(19) United States
(12) Patent Application Publication
(10) Pub. No.: US 2025/0036001 A1
(43) Pub. Date: Jan. 30, 2025

(54) OPTICAL DEVICE AND PHOTODETECTION SYSTEM

(71) Applicant: Panasonic Intellectual Property Management Co., Ltd., Osaka (JP)

(72) Inventors: TAKAIKI NOMURA, Osaka (JP); KAZUKI NAKAMURA, Osaka (JP); YASUHISA INADA, Osaka (JP)

(21) Appl. No.: 18/914,286

(22) Filed: Oct. 14, 2024

Related U.S. Application Data
(63) Continuation of application No. PCT/JP2023/003320, filed on Feb. 2, 2023.

(30) Foreign Application Priority Data
May 13, 2022 (JP) 2022-079813

(51) Int. Cl. G02F 1/19; G02F 1/1335

(52) U.S. Cl. CPC G02F 1/195; G02F 1/133524; G02F 1/133553

(57) ABSTRACT

An optical device includes a first structure, a second structure, one or more optical waveguide regions, and a seal member. The first structure has a first surface. The second structure has a second surface facing the first surface. The one or more optical waveguide regions are located between the first surface of the first structure and the second surface of the second structure and contain a liquid crystal material. The seal member fixes a spacing between the first structure and the second structure, surrounds the one or more optical waveguide regions, and includes an opening through which the liquid crystal material is injected. A width of the opening in a first direction is greater than a width of the one or more optical waveguide regions in the first direction.

### BACKGROUND

### 1. Technical Field

The present disclosure relates to an optical device and a photodetection system.

### 2. Description of the Related Art

There have conventionally been proposed various types of device that are capable of scanning space with light.

International Publication No. 2013/168266 discloses a configuration in which an optical scan can be performed with a mirror-rotating driving apparatus.

Japanese Unexamined Patent Application Publication (Translation of PCT Application) No. 2016-508235 discloses an optical phased array having a plurality of two-dimensionally arrayed nanophotonic antenna elements. Each antenna element is optically coupled to a variable optical delay line (i.e. a phase shifter). In this optical phased array, a coherent light beam is guided to each antenna element by a waveguide, and the phase of the light beam is shifted by the phase shifter. This makes it possible to vary the amplitude distribution of a far-field radiating pattern.

Japanese Unexamined Patent Application Publication No. 2013-16591 discloses an optical deflection element including: a waveguide including an optical waveguide layer through the inside of which light is guided and first distributed Bragg reflectors formed on upper and lower surfaces, respectively, of the optical waveguide layer; a light entrance through which light enters the waveguide, and a light exit formed on a surface of the waveguide to let out light having entered through the light entrance and being guided through the inside of the waveguide.

### SUMMARY

One non-limiting and exemplary embodiment provides an optical device that is capable of restraining a decrease in the intensity of emitted light or received light.

In one general aspect, the techniques disclosed here feature an optical device including a first structure, a second structure, one or more optical waveguide regions, and a seal member. The first structure has a first surface. The second structure has a second surface facing the first surface. The one or more optical waveguide regions are located between the first surface of the first structure and the second surface of the second structure and contain a liquid crystal material. The seal member fixes a spacing between the first structure and the second structure, surrounds the one or more optical waveguide regions, and includes an opening through which the liquid crystal material is injected. A width of the opening in a first direction is greater than a width of the one or more optical waveguide regions in the first direction.

It should be noted that general or specific embodiments may be implemented as a system, an apparatus, a method, an integrated circuit, a computer program, a storage medium, or any selective combination thereof. The computer-readable storage medium can include a volatile storage medium or can include a nonvolatile storage medium such as a CD-ROM (compact disc read-only memory). The apparatus may be constituted by one or more apparatuses. In a case where the apparatus is constituted by two or more apparatuses, the two or more apparatuses may be placed in one piece of equipment or may be separately placed in two or more separate pieces of equipment. The term “apparatus” herein or in the claims can not only mean one apparatus but also mean a system composed of a plurality of apparatuses.

One aspect of the present disclosure makes it possible to achieve an optical device that is capable of restraining a decrease in the intensity of emitted light or received light.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1 is a perspective view schematically showing a configuration of an optical scan device;

FIG. 2 is a diagram schematically showing an example of a cross-section structure of one waveguide element and an example of propagating light;

FIG. 3A is a diagram showing a cross-section of a waveguide array that emits light in a direction perpendicular to an exit face of the waveguide array;

FIG. 3B is a diagram showing a cross-section of a waveguide array that emits light in a direction different from a direction perpendicular to an exit face of the waveguide array;

FIG. 4 is a perspective view schematically showing a waveguide array in a three-dimensional space;

FIG. 5 is a schematic view of a waveguide array and a phase shifter array as seen from a direction (Z direction) normal to a light exit face;

FIG. 6A is a top view schematically showing a configuration of an optical scan device according to a comparative example;

FIG. 6B is a top view schematically showing a configuration of a lower structure shown in FIG. 6A;

FIG. 6C is a cross-sectional view of the optical scan device as taken along line VIC-VIC in FIG. 6A;

FIG. 7 is a photograph showing a result of an experiment in which a liquid crystal material was injected through a narrow opening in the optical scan device according to the comparative example;

FIG. 8A is a top view schematically showing a configuration of an optical device according to an exemplary Embodiment 1 of the present disclosure;

FIG. 8B is a diagram schematically showing an example of a state where an upper constituent element was removed from FIG. 8A;

FIG. 8C is a diagram schematically showing another example of the state where the upper constituent element was removed from FIG. 8A;

FIG. 8D is a diagram schematically showing still another example of the state where the upper constituent element was removed from FIG. 8A;

FIG. 9A is a cross-sectional view taken along IXA-IXA in FIG. 8A;

FIG. 9B is a cross-sectional view taken along IXB-IXB in FIG. 8A;

FIG. 9C is a cross-sectional view taken along IXC-IXC in FIG. 8A;

FIG. 10A is a cross-sectional view schematically showing a configuration of an optical device according to an exemplary Embodiment 2 of the present disclosure;

FIG. 10B is another cross-sectional view schematically showing the configuration of the optical device according to the exemplary Embodiment 2 of the present disclosure;

FIG. 10C is still another cross-sectional view schematically showing the configuration of the optical device according to the exemplary Embodiment 2 of the present disclosure;

FIG. 11A is a top view schematically showing an example of an optical device according to a modification of Embodiment 2 of the present disclosure;

FIG. 11B is a diagram schematically showing an example of a state where an upper constituent element was removed from FIG. 11A;

FIG. 11C is a diagram schematically showing another example of the state where the upper constituent element was removed from FIG. 11A;

FIG. 11D is a diagram schematically showing still another example of the state where the upper constituent element was removed from FIG. 11A;

FIG. 12A is a cross-sectional view taken along XIIA-XIIA in FIG. 11A;

FIG. 12B is a cross-sectional view taken along XIIB-XIIB in FIG. 11A;

FIG. 12C is a cross-sectional view taken along XIIC-XIIC in FIG. 11A;

FIG. 13 is a diagram showing an example configuration of an optical scan device in which elements such as an optical divider, a waveguide array, a phase shifter array, and a light source are integrated on a circuit board;

FIG. 14 is a schematic view showing how a two-dimensional scan is being executed by irradiating a distant place with a light beam such as a laser from the optical scan device; and

FIG. 15 is a block diagram showing an example configuration of a LiDAR system that is capable of generating a ranging image.

### DETAILED DESCRIPTIONS

It should be noted that the embodiments to be described below each illustrate a comprehensive and specific example. The numerical values, shapes, materials, constituent elements, placement and topology of constituent elements, steps, orders of steps, or other features that are shown in the following embodiments are just a few examples and are not intended to limit the technology of the present disclosure. Further, those of the constituent elements in the following embodiments which are not recited in an independent claim reciting the most superordinate concept are described as optional constituent elements. Further, the drawings are schematic views and are not necessarily strict illustrations. Further, in the drawings, substantially identical or similar constituent elements are given identical reference signs. A repeated description may be omitted or simplified.

### Underlying Knowledge Forming Basis of the Present Disclosure

Prior to a description of embodiments of the present disclosure, underlying knowledge forming the basis of the present disclosure is described.

The inventor found that a conventional optical scan device has difficulty in scanning space with light without making a complex apparatus configuration.

For example, the technology disclosed in International Publication No. 2013/168266 requires a mirror-rotating driving apparatus. This undesirably makes a complex apparatus configuration that is not robust against vibration.

In the optical phased array described in Japanese Unexamined Patent Application Publication (Translation of PCT Application) No. 2016-508235, it is necessary to divide light into lights, introduce the lights into a plurality of column waveguide and a plurality of row waveguides, and guide the lights to the plurality of two-dimensionally arrayed antenna elements. This results in very complex wiring of optical waveguides through which to guide the lights. This also makes it impossible to attain a great two-dimensional scanning range. Furthermore, to two-dimensionally vary the amplitude distribution of emitted light in a far field, it is necessary to connect phase shifters separately to each of the plurality of two-dimensionally arrayed antenna elements and attach phase-controlling wires to the phase shifters. This causes the phases of lights falling on the plurality of two-dimensionally arrayed antenna elements to vary by a different amount. This makes the elements very complex in configuration.

The inventor focused on the foregoing problems in the conventional technologies and studied configurations to solve these problems. The inventor found that the foregoing problems can be solved by using an optical waveguide element having a pair of mirrors facing each other and an optical waveguide layer sandwiched between the mirrors. One of the pair of mirrors of the optical waveguide element has a higher light transmittance than the other and lets out a portion of light propagating through the optical waveguide layer. As will be mentioned later, the direction of light emitted (or the angle of emission) can be changed by adjusting the refractive index or thickness of the optical waveguide layer or the wavelength of light that is inputted to the optical waveguide layer. More specifically, by changing the refractive index, the thickness, or the wavelength, a component constituting the wave number vector (wave vector) of the emitted light and acting in a direction along a lengthwise direction of the optical waveguide layer can be changed. This allows a one-dimensional scan to be achieved.

Furthermore, in a case where an array of a plurality of the optical waveguide elements is used, a two-dimensional scan can be achieved. More specifically, a direction in which lights going out from the plurality of optical waveguide elements reinforce each other can be changed by giving an appropriate phase difference to lights that are supplied to the plurality of optical waveguide elements and adjusting the phase difference. A change in phase difference brings about a change in a component constituting the wave number vector of the emitted light and acting in a direction that intersects the direction along the lengthwise direction of the optical waveguide layer. This makes it possible to achieve a two-dimensional scan. Even in a case where a two-dimensional scan is performed, it is not necessary to cause the refractive index or thickness of each of a plurality of the optical waveguide layers or the wavelength of light to vary by a different amount. That is, a two-dimensional scan can be performed by giving an appropriate phase difference to lights that are supplied to the plurality of optical waveguide layers and causing at least one of the refractive index of each of the plurality of optical waveguide layers, the thickness of each of the plurality of optical waveguide layers, or the wavelength to vary by the same amount in synchronization. In this way, an embodiment of the present disclosure makes it possible to achieve an optical two-dimensional scan through a comparatively simple configuration.

The phrase “at least one of the refractive index, the thickness, or the wavelength” herein means at least one selected from the group consisting of the refractive index of an optical waveguide layer, the thickness of an optical waveguide layer, and the wavelength of light that is inputted to an optical waveguide layer. For a change in direction of emission of light, any one of the refractive index, the thickness, and the wavelength may be controlled alone. Alternatively, the direction of emission of light may be changed by controlling any two or all of these three. In each of the following embodiments, the wavelength of light that is inputted to the optical waveguide layer may be controlled instead of or in addition to controlling the refractive index or the thickness.

The foregoing fundamental principles are similarly applicable to uses in which optical signals are received as well as uses in which light is emitted. The direction of light that can be received can be one-dimensionally changed by changing at least one of the refractive index, the thickness, or the wavelength. Furthermore, the direction of light that can be received can be two-dimensionally changed by changing a phase difference of light through a plurality of phase shifters connected separately to each of a plurality of unidirectionally-arrayed waveguide elements.

An optical scan device and an optical receiver device according to embodiments of the present disclosure can be used, for example, as an antenna in a photodetection system such as a LiDAR (light detection and ranging) system. The LiDAR system, which involves the use of short-wavelength electromagnetic waves (visible light, infrared radiation, or ultraviolet radiation), can detect a distance distribution of objects with higher resolution than a radar system that involves the use of radio waves such as millimeter waves. Such a LiDAR system is mounted, for example, on a movable body such as an automobile, a UAV (unmanned aerial vehicle, i.e. a drone), or an AGV (automated guided vehicle), and can be used as one of the crash avoidance technologies. The optical scan device and the optical receiver device are herein sometimes collectively referred to as an “optical device”. Further, a device that is used in the optical scan device or the optical receiver device is also sometimes referred to as an “optical device”.

The following describes a basic example configuration of an optical device and a principle of operation of thereof.

### Basic Example Configuration of Optical Scan Device

The following describes, as an example, a configuration of an optical scan device that performs a two-dimensional scan. Note, however, that an unnecessarily detailed description may be omitted. For example, a detailed description of a matter that is already well known may be omitted. This is intended to facilitate understanding of persons skilled in the art by avoiding making the following description unnecessarily redundant.

In the present disclosure, the term “light” means electromagnetic waves including ultraviolet radiation (ranging from approximately 10 nm to approximately 400 nm in wavelength) and infrared radiation (ranging from approximately 700 nm to approximately 1 mm in wavelength) as well as visible light (ranging approximately 400 nm to approximately 700 nm in wavelength). Ultraviolet radiation is herein sometimes referred to as “ultraviolet light”, and infrared radiation is herein sometimes referred to as “infrared light”.

In the present disclosure, an optical “scan” means changing the direction of light. A “one-dimensional scan” means changing the direction of light along a direction that intersects the direction. A “two-dimensional scan” means two-dimensionally changing the direction of light along a plane that intersects the direction.

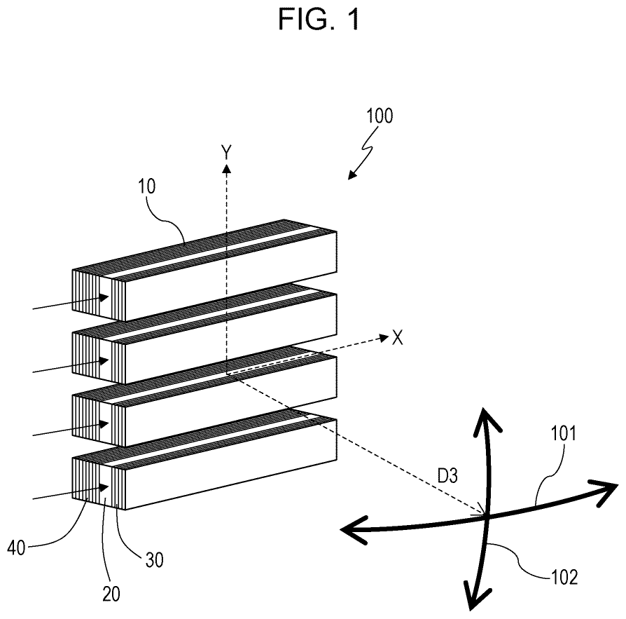

FIG. 1 is a perspective view schematically showing a configuration of an optical scan device 100. The optical scan device 100 includes a waveguide array including a plurality of waveguide elements 10. Each of the plurality of waveguide elements 10 has a shape extending in a first direction (in FIG. 1, an X direction). The plurality of waveguide elements 10 are regularly arrayed in a second direction (in FIG. 1, a Y direction) that intersects the first direction. The plurality of waveguide elements 10, while propagating light in the first direction, emit the light in a third direction D3 that intersects an imaginary plane parallel to the first and second directions. Although, in the present embodiment, the first direction (X direction) and the second direction (Y direction) are orthogonal to each other, they may not be orthogonal to each other. Although, in the present embodiment, the plurality of waveguide elements 10 are placed at equal spacings in the Y direction, they do not necessarily need to be placed at equal spacings.

It should be noted that the orientation of a structure shown in a drawing of the present disclosure is set in view of understandability of explanation and is in no way intended to restrict any actual orientation whatsoever. Further, the shape and size of the whole or a part of a structure shown in a drawing are not intended to restrict an actual shape and size.

Each of the plurality of waveguide elements 10 has first and second mirrors 30 and 40 facing each other and an optical waveguide layer 20 located between the mirror 30 and the mirror 40. Each of the mirrors 30 and 40 has a reflecting surface, situated at the interface with the optical waveguide layer 20, that intersects the third direction D3. The mirror 30, the mirror 40, and the optical waveguide layer 20 have shapes extending in the first direction (X direction).

As will be mentioned later, a plurality of the first mirrors 30 of the plurality of waveguide elements 10 may be a plurality of portions of a mirror of integral construction. Further, a plurality of the second mirrors 40 of the plurality of waveguide elements 10 may be a plurality of portions of a mirror of integral construction. Furthermore, a plurality of the optical waveguide layers 20 of the plurality of waveguide elements 10 may be a plurality of portions of an optical waveguide layer of integral construction. A plurality of waveguides can be formed by at least (1) each first mirror 30 being constructed separately from another first mirror 30, (2) each second mirror 40 being constructed separately from another second mirror 40, or (3) each optical waveguide layer 20 being constructed separately from another optical waveguide layer 20. The phrase “being constructed separately” encompasses not only placing first mirrors 30, second mirrors 40, or optical waveguide layers 20 at a physical spacing from each other but also separating first mirrors 30, second mirrors 40, or optical waveguide layers 20 from each other by placing a material of a different refractive index between them.

The reflecting surface of the first mirror 30 and the reflecting surface of the second mirror 40 face each other substantially in a parallel fashion. Of the two mirrors 30 and 40, at least the first mirror 30 has the property of transmitting a portion of light propagating through the optical waveguide layer 20. In other words, the first mirror 30 has a higher light transmittance against the light than the second mirror 40. For this reason, a portion of light propagating through the optical waveguide layer 20 is emitted outward from the first mirror 30. Such mirrors 30 and 40 can be, for example, multilayer mirrors that are formed by multilayer films of dielectrics (sometimes referred to as “multilayer reflective films”).

An optical two-dimensional scan can be achieved by controlling the phases of lights that are inputted to the respective waveguide elements 10 and, furthermore, causing the refractive indices or thicknesses of the optical waveguide layers 20 of these waveguide elements 10 or the wavelengths of lights that are inputted to the optical waveguide layers 20 to simultaneously change in synchronization.

In order to achieve such a two-dimensional scan, the inventor conducted an analysis on the principle of operation of a waveguide element 10. As a result of their analysis, the inventor succeeded in achieving an optical two-dimensional scan by driving a plurality of waveguide elements 10 in synchronization.

As shown in FIG. 1, inputting light to each waveguide element 10 causes light to exit the waveguide element 10 through an exit surface of the waveguide element 10. The exit face is located on the side opposite to the reflecting surface of the first mirror 30. The direction D3 of the emitted light depends on the refractive index and thickness of the optical waveguide layer and the wavelength of light. In the present embodiment, at least one of the refractive index of each optical waveguide layer, the thickness of each optical waveguide layer, or the wavelength is controlled in synchronization so that lights that are emitted separately from each waveguide element 10 are oriented in substantially the same direction. This makes it possible to change X-direction components of the wave number vectors of lights that are emitted from the plurality of waveguide elements 10. In other words, this makes it possible to change the direction D3 of the emitted light along a direction 101 shown in FIG. 1.

Furthermore, since the lights that are emitted from the plurality of waveguide elements 10 are oriented in the same direction, the emitted lights interfere with one another. By controlling the phases of the lights that are emitted from the respective waveguide elements 10, a direction in which the lights reinforce one another by interference can be changed. For example, in a case where a plurality of waveguide elements 10 of the same size are placed at equal spacings in the Y direction, lights differing in phase by a constant amount from one another are inputted to the plurality of waveguide elements 10. By changing the phase differences, Y-direction components of the wave number vectors of the emitted lights can be changed. In other words, by varying phase differences among lights that are introduced into the plurality of waveguide elements 10, the direction D3, in which the emitted lights reinforce one another by interference, can be changed along a direction 102 shown in FIG. 1. This makes it possible to achieve an optical two-dimensional scan.

The following describes the principle of operation of the optical scan device 100.

### Principle of Operation of Waveguide Element

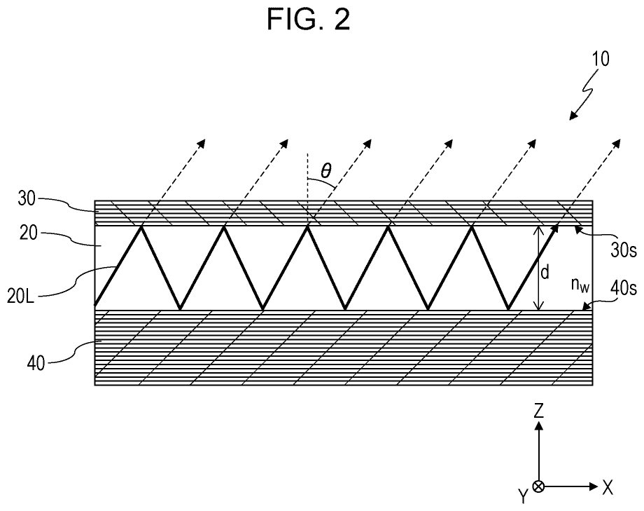

FIG. 2 is a diagram schematically showing an example of a cross-section structure of one waveguide element 10 and an example of propagating light. With a Z direction being a direction perpendicular of the X and Y directions shown in FIG. 1, FIG. 2 schematically shows a cross-section parallel to an X-Z plane of the waveguide element 10. The waveguide element 10 is configured such that the first mirror 30 and the second mirror 40 are disposed so as to the optical waveguide layer 20 is sandwiched between the first mirror 30 and the second mirror 40. The first mirror 30 has a first reflecting surface 30s. The second mirror 40 has a second reflecting surface 40s facing the first reflecting surface 30s. Light 20L introduced into the optical waveguide layer 20 through one end of the optical waveguide layer 20 in the X direction propagates through the inside of the optical waveguide layer 20 while being repeatedly reflected by the first reflecting surface 30s of the first mirror 30, which is provided on an upper surface (in FIG. 2, the upper side) of the optical waveguide layer 20, and the second reflecting surface 40s of the second mirror 40, which is provided on a lower surface (in FIG. 2, the lower side) of the optical waveguide layer 20. The light transmittance of the first mirror 30 is higher than the light transmittance of the second mirror 40. For this reason, a portion of the light can be outputted mainly from the first mirror 30.

In the case of a waveguide such as a common optical fiber, light propagates along the waveguide while repeating total reflection. On the other hand, in the case of a waveguide element 10 in the present embodiment, light propagates while being repeatedly reflected by the mirrors 30 and 40 disposed above and below, respectively, the optical waveguide layer 20. For this reason, there are no restrictions on angles of propagation of light. The term “angle of propagation of light” here means an angle of incidence on the interface between the mirror 30 or 40 and the optical waveguide layer 20. Light falling on the mirror 30 or 40 at an angle that is closer to the perpendicular can also be propagated. That is, light falling on the interface at an angle that is smaller than a critical angle of total reflection can also be propagated. This causes the group speed of light in the direction of propagation of light to be much lower than the speed of light in free space. For this reason, the waveguide element 10 has such a property that conditions for propagation of light vary greatly according to changes in the wavelength of light, the thickness of the optical waveguide layer 20, and the refractive index of the optical waveguide layer 20. Such a waveguide is referred to as a “reflective waveguide” or a “slow light waveguide”.

The angle of emission θ of light that is emitted into the air from the waveguide element 10 is expressed by Formula (1) as follows:

$$sin θ = \sqrt{{n}_{w}^{2} - {( \frac{m λ}{2 d} )}^{2}} \qquad ( 1 )$$

As can be seen from Formula (1), the direction of emission of light can be changed by changing any of the wavelength λ of light in the air, the refractive index n_{w} of the optical waveguide layer 20, and the thickness d of the optical waveguide layer 20.

For example, in a case where n_{w}=2, d=387 nm, λ=1550 nm, and m=1, the angle of emission is 0 degree. Changing the refractive index from this state to n_{w}=2.2 changes the angle of emission to approximately 66 degrees. Meanwhile, changing the thickness to d=420 nm without changing the refractive index changes the angle of emission to approximately 51 degrees. Changing the wavelength to λ=1500 nm without changing the refractive index or the thickness changes the angle of emission to approximately 30 degrees. In this way, the direction of emission of light can be greatly changed by changing any of the wavelength λ of light, the refractive index n_{w} of the optical waveguide layer 20, and the thickness d of the optical waveguide layer 20.

Accordingly, the optical scan device 100 of the present disclosure controls the direction of emission of light by controlling at least one of the wavelength λ of light that is inputted to each of the optical waveguide layers 20, the refractive index n_{w} of each of the optical waveguide layers 20, or the thickness d of each of the optical waveguide layers 20. The wavelength λ of light may be kept constant without being changed during operation. In that case, an optical scan can be achieved through a simpler configuration. The wavelength λ is not limited to a particular wavelength. For example, the wavelength λ can be included in a wavelength range of 400 nm to 1100 nm (i.e. from visible light to near-infrared light) within which high detection sensitivity is attained by a common photodetector or image sensor that detects light by absorbing light through silicon (Si). In another example, the wavelength λ can be included in a near-infrared wavelength range of 1260 nm to 1625 nm within which an optical fiber or a Si waveguide has a comparatively small transmission loss. It should be noted that these wavelength ranges are merely examples. A wavelength range of light that is used is not limited to a wavelength range of visible light or infrared light but may, for example, be a wavelength range of ultraviolet light.

In order to change the direction of emitted light, the optical scan device 100 can include a first adjusting element that changes at least one of the refractive index of the optical waveguide layer 20 of each waveguide element 10, the thickness of the optical waveguide layer 20 of each waveguide element 10, or the wavelength.

As stated above, using a waveguide element 10 makes it possible to greatly change the direction of emission of light by changing at least one of the refractive index n_{w} of the optical waveguide layer 20, the thickness d of the optical waveguide layer 20, or the wavelength 2. This makes it possible to change, to a direction along the waveguide element 10, the angle of emission of light that is emitted from the mirror 30. By using at least one waveguide element 10, such a one-dimensional scan can be achieved.

In order to adjust the refractive index of at least a part of the optical waveguide layer 20, the optical waveguide layer 20 may contain a liquid crystal material or an electro-optical material. The optical waveguide layer 20 can be sandwiched between a pair of electrodes. By applying a voltage to the pair of electrodes, the refractive index of the optical waveguide layer 20 can be changed.

In order to adjust the thickness of the optical waveguide layer 20, at least one actuator may be connected, for example, to at least either the first mirror 30 or the second mirror 40. The thickness of the optical waveguide layer 20 can be changed by varying the distance between the first mirror 30 and the second mirror 40 through the at least one actuator. When the optical waveguide layer 20 is formed from liquid, the thickness of the optical waveguide layer 20 can easily change.

### Principle of Operation of Two-Dimensional Scan

In a waveguide array in which a plurality of waveguide elements 10 are unidirectionally arrayed, the interference of lights that are emitted from the respective waveguide elements 10 brings about a change in direction of emission of light. By adjusting the phases of lights that are supplied separately to each waveguide element 10, the direction of emission of light can be changed. The following describes the principles on which it is based.

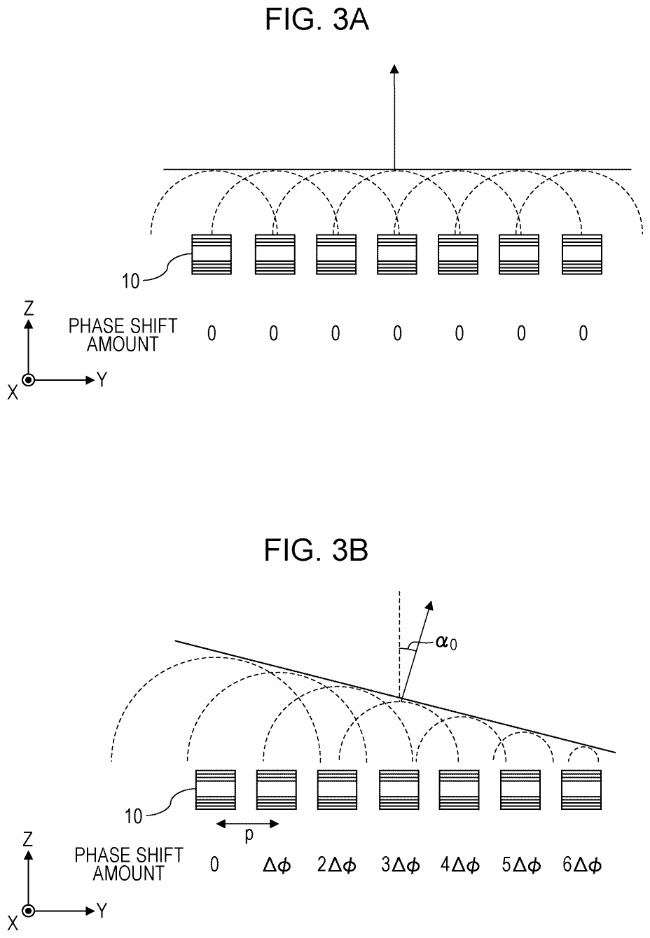

FIG. 3A is a diagram showing a cross-section of a waveguide array that emits light in a direction perpendicular to an exit face of the waveguide array. FIG. 3A also describes the phase shift amounts of lights that propagate separately through each waveguide element 10. Note here that the phase shift amounts are values based on the phase of the light that propagates through the leftmost waveguide element 10. The waveguide array of the present embodiment includes a plurality of waveguide elements 10 arrayed at equal spacings. In FIG. 3A, the dashed circular arcs indicate the wave fronts of lights that are emitted separately from each waveguide element 10. The straight line indicates a wave front that is formed by the interference of the lights. The arrow indicates the direction of light that is emitted from the waveguide array (i.e. the direction of a wave number vector). In the example shown in FIG. 3A, lights propagating through the optical waveguide layers 20 of each separate waveguide element 10 are identical in phase to one another. In this case, the light is emitted in a direction (Z direction) perpendicular to both an array direction (Y direction) of the waveguide elements 10 and a direction (X direction) in which the optical waveguide layers 20 extend.

FIG. 3B is a diagram showing a cross-section of a waveguide array that emits light in a direction different from a direction perpendicular to an exit face of the waveguide array. In the example shown in FIG. 3B, lights propagating through the optical waveguide layers 20 of the plurality of waveguide elements 10 differ in phase from one another by a constant amount (Δφ) in the array direction. In this case, the light is emitted in a direction different from the Z direction. By varying Δφ, a Y-direction component of the wave number vector of the light can be changed. Assuming that p is the center-to-center distance between two adjacent waveguide elements 10, the angle of emission do of light is expressed by Formula (2) as follows:

$$sin {α}_{0} = \frac{Δϕλ}{2 π p} \qquad ( 2 )$$

In the example shown in FIG. 2, the direction of emission of light is parallel to the X-Z plane. That is, α₀=0°. In each of the examples shown in FIGS. 3A and 3B, the direction of light that is emitted from the optical scan device 100 is parallel to a Y-Z plane. That is, θ=0°. However, in general, the direction of light that is emitted from the optical scan device 100 is not parallel to the X-Z plane or the Y-Z plane. That is, θ≠0° and α₀≠0°.

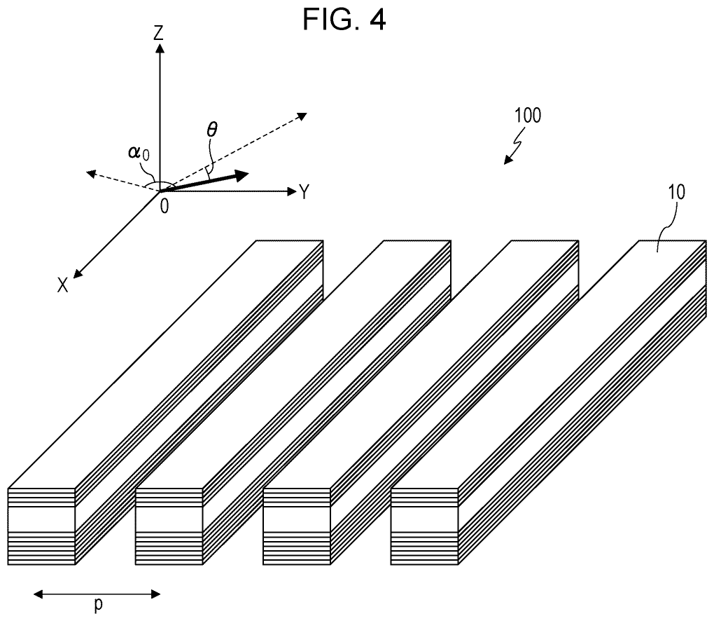

FIG. 4 is a perspective view schematically showing a waveguide array in a three-dimensional space. The thick arrow shown in FIG. 4 represents the direction of light that is emitted from the optical scan device 100. θ is the angle formed by the direction of emission of light and the Y-Z plane. θ satisfies Formula (1). α₀ is the angle formed by the direction of emission of light and the X-Z plane. α₀ satisfies Formula (2).

Phase Control of Light that is Introduced into Waveguide Array

In order to control the phases of lights that are emitted from the respective waveguide elements 10, a phase shifter that changes the phase of light may be provided, for example, at a stage prior to the introduction of light into a waveguide element 10. The optical scan device 100 of the present disclosure includes a plurality of phase shifters connected separately to each of the plurality of waveguide elements 10 and a second adjusting element that adjusts the phases of lights that propagate separately through each phase shifter. Each phase shifter includes a waveguide joined either directly or via another waveguide to the optical waveguide layer 20 of a corresponding one of the plurality of waveguide elements 10. The second adjusting element varies differences in phase among lights propagating from the plurality of phase shifters to the plurality of waveguide elements 10 and thereby changes the direction (i.e. the third direction D3) of light that is emitted from the plurality of 1 waveguide elements 10. As is the case with the waveguide array, a plurality of arrayed phase shifters are hereinafter referred to as a “phase shifter array”.

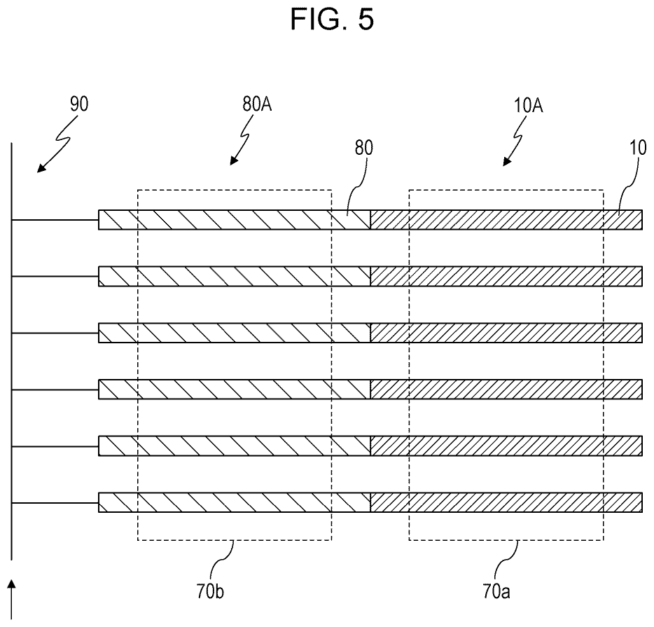

FIG. 5 is a schematic view of a waveguide array 10A and a phase shifter array 80A as seen from a direction (Z direction) normal to a light exit face. In the example shown in FIG. 5, all phase shifters 80 have the same propagation characteristics, and all waveguide elements 10 have the same propagation characteristics. The phase shifter 80 and the waveguide elements 10 may be the same in length or may be different in length. In a case where the phase shifters 80 are equal in length, the respective phase shift amounts can be adjusted, for example, by a driving voltage. Further, by making a structure in which the lengths of the phase shifters 80 vary in equal steps, phase shifts can be given in equal steps by the same driving voltage. Furthermore, this optical scan device 100 further includes an optical divider 90 that divides light into lights and supplies the lights to the plurality of phase shifters 80, a first driving circuit 70a that drives each waveguide element 10, and a second driving circuit 70b that drives each phase shifter 80. The straight arrow shown in FIG. 5 indicates the inputting of light. A two-dimensional scan can be achieved by independently controlling the first driving circuit 70a and the second driving circuit 70b, which are separately provided. In this example, the first driving circuit 70a functions as one element of the first adjusting element, and the second driving circuit 70b functions as one element of the second adjusting element.

The first driving circuit 70a changes at least either the refractive index or thickness of the optical waveguide layer 20 of each waveguide element 10 and thereby changes the angle of light that is emitted from the optical waveguide layer 20. The second driving circuit 70b changes the refractive index of the optical waveguide layer 20 of each phase shifter 80 and thereby changes the phase of light that propagates through the inside of the optical waveguide layer 20. The optical divider 90 may be constituted by a waveguide through which light propagates by total reflection or may be constituted by a reflective waveguide that is similar to a waveguide element 10.

The lights divided by the optical divider 90 may be introduced into the phase shifters 80 after the phases of the lights have been controlled, respectively. This phase control may involve the use of, for example, a passive phase control structure based on an adjustment of the lengths of waveguides leading to the phase shifters 80. Alternatively, it is possible to use phase shifters that are similar in function to the phase shifters 80 and that can be controlled by electrical signals. The phases may be adjusted by such a method prior to introduction into the phase shifters 80, for example, so that lights of equal phases are supplied to all phase shifters 80. Such an adjustment makes it possible to simplify the control of each phase shifter 80 by the second driving circuit 70b.

An optical device that is similar in configuration to the aforementioned optical scan device 100 can also be utilized as an optical receiver device. Details of the principle of operation of the optical device, a method of operation of the optical device, and the like are disclosed in U.S. Patent Application Publication No. 2018/0224709, the disclosure of which is hereby incorporated by reference herein in its entirety.

Problem Arising from Injection of Liquid Crystal Material into Optical Device

An optical device 100 can be fabricated by bonding together an upper structure including a first mirror 30 and a lower structure including a second mirror 40. The bonding can involve the use of a seal member such as ultraviolet curable resin or thermosetting resin. For an optical scan through the application of a voltage, the optical waveguide layer 20 can contain, for example, a liquid crystal material. Injection of the liquid crystal material into the optical device 100 can involve the utilization of, for example, vacuum encapsulation. Injecting the liquid crystal material into a space surrounded by the seal member makes it possible to avoid vacuum leaks during the injection of the liquid crystal material.

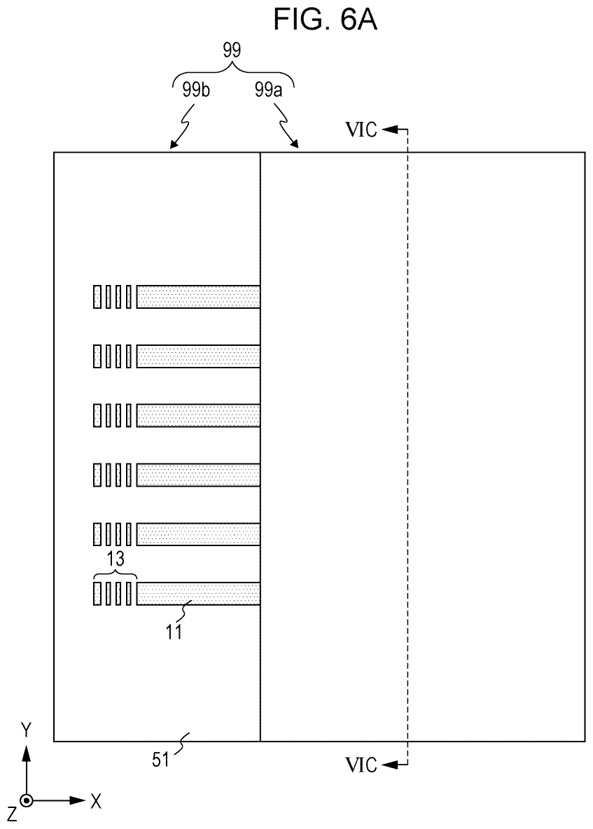

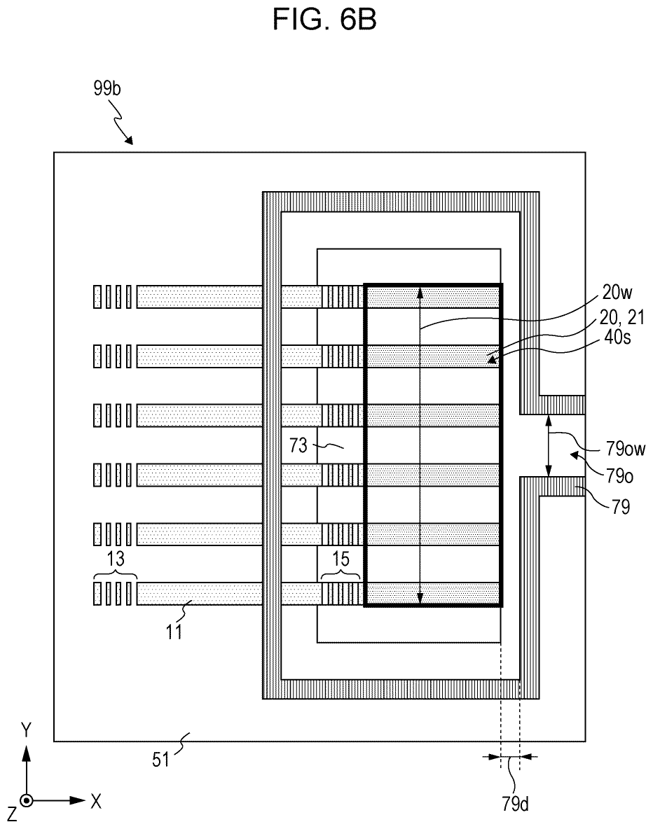

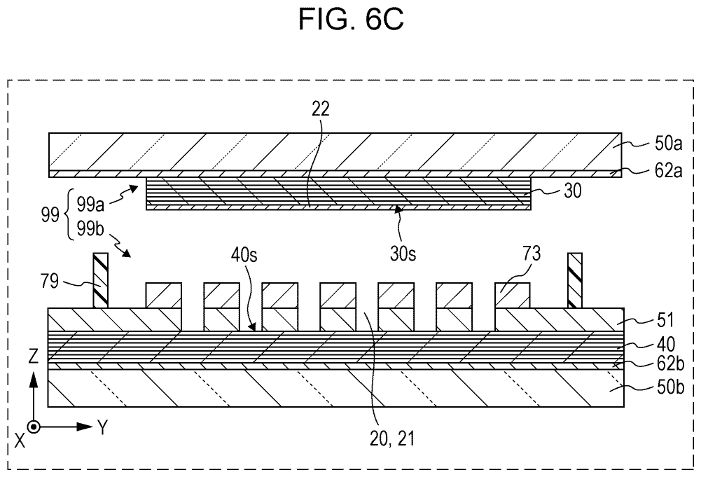

A problem arising from injection of a liquid crystal material into an optical device according to a comparative example is described here with reference to FIGS. 6A to 6C. The following description describes the optical device as an optical scan device. FIG. 6A is a top view schematically showing a configuration of an optical device 99 according to a comparative example. The optical device 99 shown in FIG. 6A includes an upper structure 99a, a lower structure 99b, a plurality of optical waveguide regions (not illustrated), an alignment film, and a seal member. FIG. 6B is a top view schematically showing a configuration of a lower structure 99b shown in FIG. 6A. FIG. 6C is a cross-sectional view of the optical device 99 as taken along line VIC-VIC in FIG. 6A. However, for case of comprehension of explanation, FIG. 6C shows a state where the upper structure 99a and the lower structure 99b are separated from each other.

The upper structure 99a includes a substrate 50a, an electrode 62a, and a mirror 30. The lower structure 99b includes a substrate 50b, an electrode 62b, a mirror 40, a dielectric layer 51, a plurality of optical waveguides 11, and a plurality of partition walls 73. A region that is equivalent to the aforementioned optical waveguide layer 20 is formed between a reflecting surface 30s of the mirror 30 and a reflecting surface 40s of the mirror 40. Such a region is referred to as an “optical waveguide region 20”. In the example shown in FIG. 6C, a plurality of optical waveguide regions 20 are formed. The number of optical waveguide regions 20 is 6. An alignment film 22 is provided on the reflecting surface 30s of the mirror 30. A seal member 79 is provided on the dielectric layer 51 so as to surround the plurality of optical waveguide regions 20 and the plurality of partition walls 73. After the upper structure 99a and the lower structure 99b have been bonded together with the seal member 79, a liquid crystal material is injected through an opening 790 of the seal member 79. After that, the opening 790 is closed by the same member as the seal member 79. Each constituent element will be described in detail later.

In the example shown in FIG. 6C, in a case where the optical waveguide layer 20 contains a liquid crystal material 21, the alignment film 22 is provided on the reflecting surface 30s of the mirror 30 in order to align the liquid crystal material 21. The alignment film 21 is obtained by subjecting a film such as a polyimide film to alignment processing. Alignment processing is executed by a rubbing method by which a film is rubbed in a desired direction of alignment with a roll with nylon cloth wounded therearound or a photo-alignment method by which a film is irradiated with polarized ultraviolet radiation whose direction of polarization coincides with a desired direction of alignment. The rubbing method gives a strong alignment-regulating force. Meanwhile, since a film having unevenness has a portion that cannot be rubbed with a roller, it is not easy to uniformly subject such a film to alignment processing in its entirety. On the other hand, the photo-alignment method makes it possible to uniformly subject even a film having unevenness to alignment processing in its entirety, as long as photoirradiation is possible. Meanwhile, the photo-alignment method is weak in alignment-regulating force.

In the example shown in FIG. 6C, while the upper structure 99a has a flat surface that is equivalent to the reflecting surface 30s of the first mirror 30, the lower structure 99b has an uneven surface formed by the mirror 40, the dielectric layer 51, and the plurality of partition walls 73. While a flat polyimide film can be provided on the flat surface of the upper structure 99a, a flat polyimide film cannot be provided on the uneven surface of the lower structure 99b. Accordingly, while the alignment film 22, which was subjected to alignment processing by the rubbing method, is provided on the flat surface of the upper structure 99a, such an alignment film cannot be provided on the uneven surface of the lower structure 99b. As a result of that, an alignment-regulating force in the plurality of optical waveguide regions 20 is not very strong. Even if an alignment film subjected to alignment processing by the photo-alignment method is provided on the uneven surface of the lower structure 99b, there will no substantial increase in alignment-regulating force in the optical waveguide regions 20.

In the example shown in FIG. 6B, a width 79ow of the opening 790 in the Y direction is narrower than a width 20w of the plurality of optical waveguide regions 20 in the Y direction and is approximately ⅕ of the width 20w of the plurality of optical waveguide regions 20 in the Y direction. When seen from the Z direction, the width 20w of the plurality of optical waveguide regions 20 in the Y direction is equivalent to a dimension in the Y direction of the smallest rectangle that includes all of the plurality of optical waveguide regions 20. A region enclosed by a heavy line in FIG. 6B represents the rectangle. Injecting a liquid crystal material through such a narrow opening 790 causes the liquid crystal material to flow in a fan-like form from the opening 790 into the plurality of optical waveguide regions 20. As a result of that, there occur variations in the alignment of the liquid crystal material 21 within the plurality of optical waveguide regions 20 due to fluidized alignment, as an alignment-regulating force in the optical waveguide regions 20 is not very strong.

The occurrence of variations in the alignment of the liquid crystal material 21 within the plurality of optical waveguide regions 20 cause shifts in the refractive index of the plurality of optical waveguide regions 20. The angle of emission of light that is emitted outward via the upper structure 99a from each optical waveguide region 20 depends on the refractive index of that optical waveguide region 20. Accordingly, in a case where there are shifts in the refractive index of guided light in the plurality of optical waveguide regions 20, the angles of emission of lights that are emitted via the upper structure 99a from the plurality of optical waveguide regions 20 do not come into line, so that there is a possibility that the intensity of emitted light may decrease.

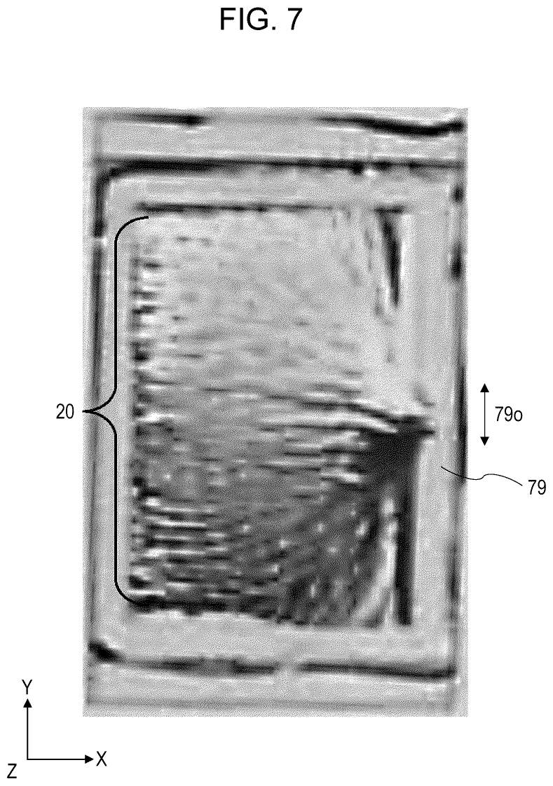

FIG. 7 is a photograph showing a result of an experiment in which a liquid crystal material was injected through a narrow opening 790 under vacuum lower than or equal to 0.5 Pa in the optical device 99 according to the comparative example. In this experiment, the width of the opening 790 in the Y direction is narrower than the width of the plurality of optical waveguide regions 20 in the Y direction. The width of the opening 790 in the Y direction was 600 μm, and the number of optical waveguide regions 20 was approximately 20. As shown in FIG. 7, there occur variations in the alignment of the liquid crystal material due to fluidized alignment within a plurality of optical waveguide regions 20 surrounded by the seal member 79.

The inventor found the aforementioned problem and arrived at an optical device according to an embodiment of the present disclosure that can reduce the occurrence of variations in alignment of a liquid crystal material due to fluidized alignment. The optical device according to the present embodiment includes a first structure and a second structure. The optical device according to the present embodiment further includes, between the first structure and the second structure, one or more optical waveguide regions and a seal member surrounding the one or more optical waveguide regions. The seal member has, in a direction, an opening through which to inject a liquid crystal material, and a width of the opening is wider than a width on the one or more optical waveguide regions in the direction. By injecting the liquid crystal material through such a wide opening, the occurrence of variations in the alignment of the liquid crystal material in the one or more optical waveguide regions due to fluidized alignment can be reduced. As a result of that, an optical device that is capable of restraining a decrease in the intensity of emitted light can be achieved. The optical device functions not only as an optical scan device but also as an optical receiver device as will be described later. Therefore, the optical device makes it also possible to restrain a decrease in the intensity of received light. The following describes an optical device according to an embodiment of the present disclosure and a photodetection system including the optical device.

An optical device according to a first item includes a first structure, a second structure, one or more optical waveguide regions, and a seal member. The first structure has a first surface. The second structure has a second surface facing the first surface. The one or more optical waveguide regions are located between the first surface of the first structure and the second surface of the second structure and contain a liquid crystal material. The seal member fixes a spacing between the first structure and the second structure, surrounds the one or more optical waveguide regions, and includes an opening through which the liquid crystal material is injected. A width of the opening in a first direction is greater than a width of the one or more optical waveguide regions in the first direction.

This optical device makes it possible to restrain a decrease in the intensity of emitted light or received light.

An optical device according to a second item is directed to the optical device according to the first item, wherein one or more spacers are provided in at least either the opening of the seal member or an area around the opening.

This optical device makes it possible to hold a spacing between the first structure and the second structure substantially constant regardless of position in the opening and the area around the opening.

An optical device according to a third item is directed to the optical device according to the second item, wherein the one or more spacers include a plurality of spacers.

This optical device makes it possible to further improve the effect of holding the spacing between the first structure and the second structure substantially constant.

An optical device according to a fourth item is directed to the optical device according to the third item, wherein a spacing between two of the plurality of spacers that are adjacent to each other is greater than a maximum width of each of the two spacers.

This optical device makes it possible to, in injecting the liquid crystal material through the opening, reduce the possibility of the plurality of spacers causing variations in the alignment of the liquid crystal material.

An optical device according to a fifth item is directed to the optical device according to any of the first to fourth items, wherein the width of the opening in the first direction is 1.05 times or more as great as the width of the one or more optical waveguide regions in the first direction.

This optical device makes it possible to, in injecting the liquid crystal material through the opening, make the direction of flow of the liquid crystal material constant and reduce the occurrence of variations in the alignment of the liquid crystal material from occurring due to fluidized alignment, even if an alignment-regulating force in the one or more optical waveguide regions is not very strong.

An optical device according to a sixth item is directed to the optical device according to any of the first to fifth items, wherein when seen from a direction perpendicular to the first surface, a shortest distance between the one or more optical waveguide regions and the opening is 0.2 time or less as great as the width of the one or more optical waveguide regions in the first direction.

The optical device makes it possible to restrain an increase in size of the optical device.

An optical device according to a seventh item is directed to the optical device according to any of the first to sixth items, wherein the one or more optical waveguide regions guide light in a second direction that intersects the first direction.

This optical device makes it possible to easily inject the liquid crystal material into the one or more optical waveguide regions.

An optical device according to an eighth item is directed to the optical device according to any of the first to seventh items, wherein the one or more optical waveguide regions are a plurality of optical waveguide regions arranged along the first direction.

This optical device makes it possible to change, along the first direction, the direction of emitted light that is emitted from the plurality of optical waveguide regions or the direction of received light that is taken into the plurality of optical waveguide regions.

An optical device according to a ninth item is directed to the optical device according to the eighth item, further including a plurality of optical waveguides connected separately to each of the plurality of optical waveguide regions. Each of the optical waveguides includes a first grating for coupling the light to a corresponding one of the optical waveguide regions.

This optical device makes it possible to efficiently couple light from each optical waveguide to a corresponding one of the optical waveguide regions via the first grating.

An optical device according to a tenth item is directed to the optical device according to the ninth item, wherein each of the optical waveguides includes a portion that, when seen from a direction perpendicular to the first surface, does not overlap either the first structure or the second structure, and includes a second grating in the portion.

This optical device makes it possible to couple light from outside to each optical waveguide via the second grating.

An optical device according to an eleventh item is directed to the optical device according to any of the eighth to tenth items, further including a plurality of phase shifters connected either directly or via the optical waveguides separately to each of the plurality of optical waveguide regions.

This optical device makes it possible to change the direction of emitted light or the direction of received light along the first direction by using the plurality of phase shifters.

An optical device according to a twelfth item is directed to the optical device according to any of the first to eleventh items, wherein the first structure includes a first mirror, and the second structure includes a second mirror. The first surface has at least a part of a reflecting surface of the first mirror, and the second surface has at least a part of a reflecting surface of the second mirror.

In this optical device, a slow light waveguide including the first mirror, the second mirror, and the one or more optical waveguide regions is formed.

An optical device according to a thirteenth item is directed to the optical device according to any of the first to twelfth items, wherein the one or more optical waveguide regions include a structure that is capable of adjusting a refractive index of the liquid crystal material. A direction of light that is emitted from the one or more optical waveguide regions via the first structure or the second structure or a direction of incidence of light that is taken into the one or more optical waveguide regions via the first structure or the second structure is able to be changed by changing the refractive index of the liquid crystal material.

This optical device can function as an optical scan device or an optical receiver device.

An optical device according to a fourteenth item is directed to the optical device according to the thirteenth item, further including a pair of electrodes between which the one or more optical waveguide regions are sandwiched. The refractive index of the liquid crystal material is able to be changed by applying a voltage to the pair of electrodes.

This optical device makes it possible to change the refractive index of the liquid crystal material by applying a voltage to the pair of electrodes.

In the present disclosure, all or some of the circuits, units, apparatuses, members, or sections or all or some of the functional blocks in the block diagrams can be implemented as one or more of electronic circuits including, but not limited to, a semiconductor device, a semiconductor integrated circuit (IC), or an LSI (large scale integration). The LSI or IC can be integrated into one chip, or also can be a combination of multiple chips. For example, functional blocks other than a memory may be integrated into one chip. The name used here is LSI or IC, but it may also be called system LSI, VLSI (very large scale integration), or ULSI (ultra large scale integration) depending on the degree of integration. A Field Programmable Gate Array (FPGA) that can be programmed after manufacturing an LSI or a reconfigurable logic device that allows reconfiguration of the connection or setup of circuit cells inside the LSI can be used for the same purpose.

Further, it is also possible that all or some of the functions or operations of the circuits, units, apparatuses, members, or sections are implemented by executing software. In such a case, the software is stored on one or more non-transitory storage media such as a ROM, an optical disk, or a hard disk drive, and when the software is executed by a processor, the software causes the processor together with peripheral devices to execute the functions specified in the software. A system or an apparatus may include such one or more non-transitory storage media on which the software is stored and a processor together with necessary hardware devices such as an interface.

### Embodiment 1

### Optical Device

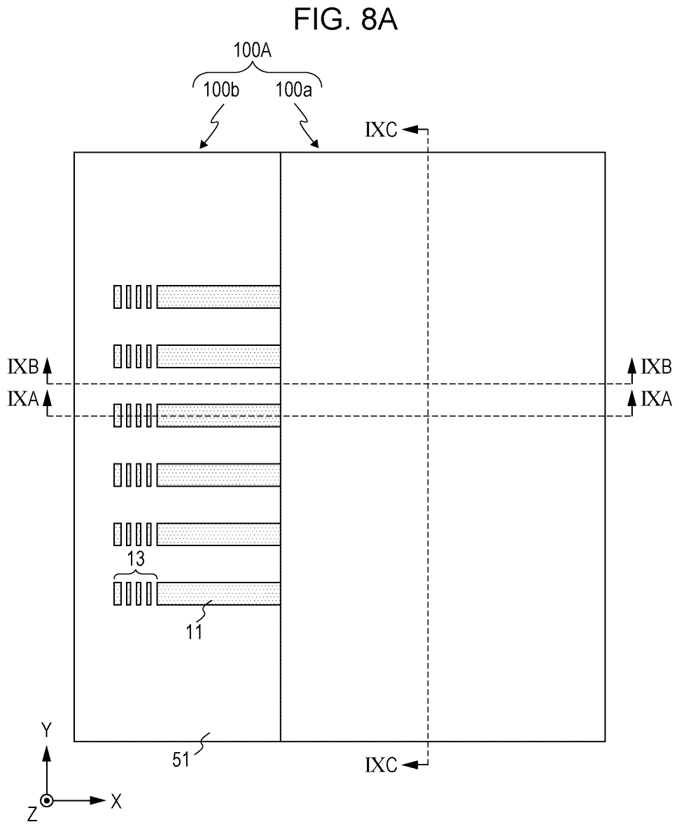

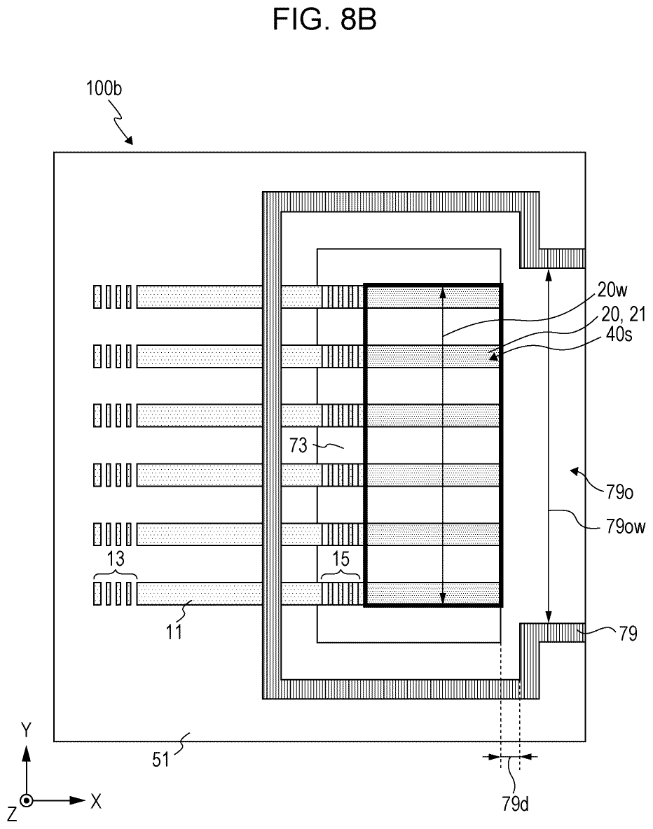

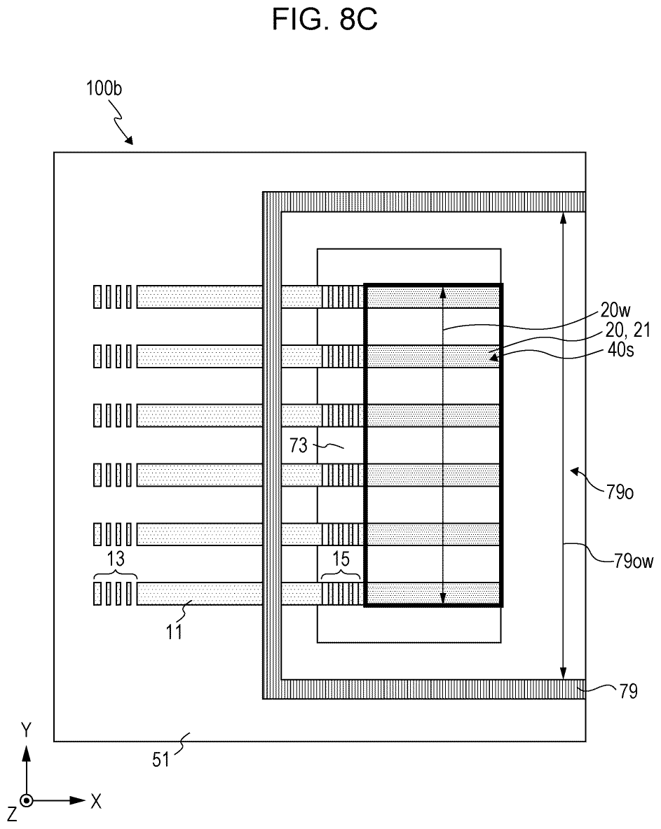

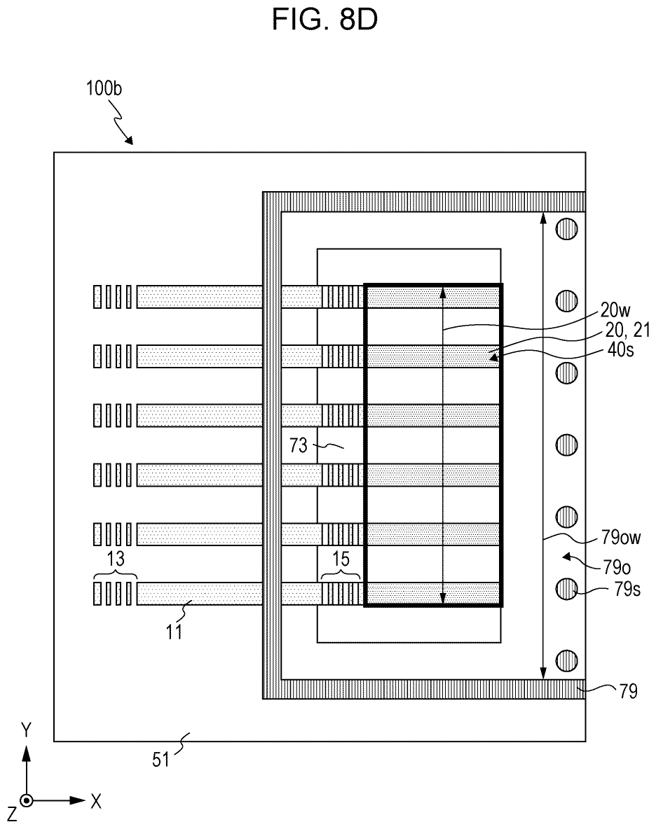

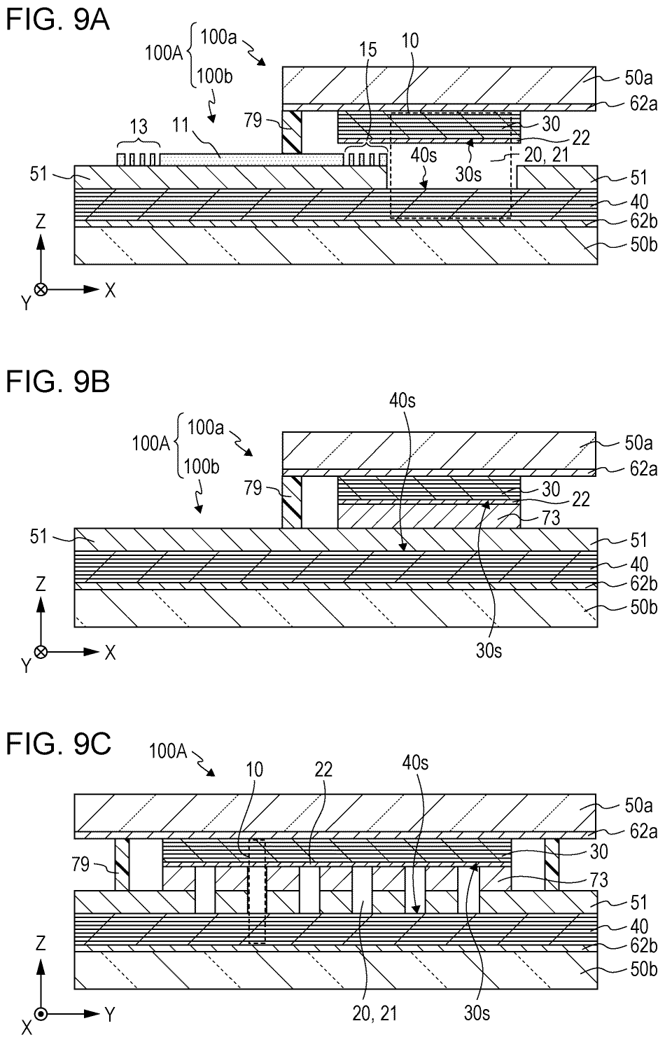

In the following, an optical device according to Embodiment 1 of the present disclosure is described with reference to FIGS. 8A to 9C. The following description describes the optical device as an optical scan device. FIG. 8A is a top view schematically showing a configuration of an optical device according to an exemplary Embodiment 1 of the present disclosure. FIGS. 8B to 8D are diagrams each schematically showing an example of a state where an upper constituent element was removed from FIG. 8A. FIGS. 9A, 9B, and 9C are a cross-sectional view taken along IXA-IXA, a cross-sectional view taken along IXB-IXB, and a cross-sectional view taken along IXC-IXC in FIG. 8A, respectively.

An optical device 100A shown in FIGS. 9A to 9C includes an upper structure 100a, a lower structure 100b, a plurality of optical waveguide regions 20, an alignment film 22, and a seal member 79. As shown in FIG. 8D, the optical device 100A may further include a plurality of spacers 79s. The optical device 100A can be fabricated by a process of bonding the upper structure 100a and the lower structure 100b together and injecting a liquid crystal material into a space sandwiched between those structures. Parts of the space into which the liquid crystal material was injected are the plurality of optical waveguide regions 20. The term “above” herein refers to a side at which the upper structure 100a is located, and the term “below” herein refers to a side at which the lower structure 100b is located. The terms “upper”, “lower”, “above”, and “below” are not intended to restrict the orientation of the optical device 100A during use, and the optical device 100A may be facing in any orientation.

The upper structure 100a is herein also referred to as a “first structure 100a”, and the lower structure 100b is herein also referred to as a “second structure 100b”. A portion of a surface of the upper structure 100a that faces the lower structure 100b is referred to as a “first surface”. A portion of a surface of the lower structure 100b that faces the upper structure 100a is referred to as a “second surface”. The first surface and the second surface face each other. In the following description, the first surface of the first structure 100a is also referred to as a “lower surface”, and the second surface of the second structure 100b is also referred to as an “upper surface”.

As shown in FIGS. 9A to 9C, the upper structure 100a includes a substrate 50a, an electrode 62a, and a mirror 30. The electrode 62a is provided on the substrate 50a. The mirror 30 is provided on the electrode 62a. The alignment film 22 is provided on the mirror 30. The lower surface of the upper structure 100a has at least a part of a reflecting surface 30s of the mirror 30. The lower surface of the upper structure 100a may have the whole of the reflecting surface 30s of the mirror 30 as shown in FIG. 9C or, in a case where a part of the reflecting surface 30s is exposed, may have the part.

As shown in FIGS. 8B to 9C, the lower structure 100b includes a substrate 50b, an electrode 62b, a mirror 40, a dielectric layer 51, a plurality of partition walls 73, and a plurality of optical waveguides 11. The electrode 62b is provided on the substrate 50b. The mirror 40 is provided on the electrode 62b. A reflecting surface 40s of the mirror 40 faces the reflecting surface 30s of the mirror 30. The dielectric layer 51 is provided on the mirror 40. The plurality of partition walls 73, the seal member 79, and the plurality of optical waveguides 11 are provided on the dielectric layer 51. As shown in FIG. 8D, the plurality of spacers 79s may be further provided on the dielectric layer 51.

The plurality of optical waveguide regions 20 are located between the reflecting surface 30s of the mirror 30 and the reflecting surface 40s of the mirror 40. In the example shown in FIG. 9C, a plurality of optical waveguide regions 20 arrayed along the Y direction are formed between the plurality of partition walls 73. Although, in the example shown in FIG. 9C, the number of optical waveguide regions 20 is 6, this number is not intended to impose any limitation. The number of optical waveguide regions 20 is any number that is greater than or equal to 1. Each of the optical waveguide regions 20, a portion of the mirror 30 that overlaps that optical waveguide region 20 when seen from the Z direction, and a portion of the mirror 40 that overlaps that optical waveguide region 20 when seen from the Z direction form an optical waveguide 10. The optical waveguide 10 functions as the aforementioned slow light waveguide.

The alignment film 22 is provided on the reflecting surface 30s of the mirror 30 in the upper structure 100a before the upper structure 100a and the lower structure 100b are bonded together. Similarly, the seal member 79 and the plurality of spacers 79s are provided on the dielectric layer 51 in the lower structure 100b before the upper structure 100a and the lower structure 100b are bonded together.

As shown in FIGS. 6B and 8B to 8D, the optical device 100A according to Embodiment 1 differs in size of the width 79ow of the opening 790 from the optical device 99 according to the comparative example. As will be described in detail later, the optical device 100A according to Embodiment 1 differs from the optical device 99 according to the comparative example in that the width 79ow of the opening 790 in the Y direction is greater than the width 20w of the plurality of optical waveguide regions 20 in the Y direction. By injecting the liquid crystal material through such a wide opening 790, the occurrence of variations in the alignment of the liquid crystal material 21 due to fluidized alignment can be reduced, even if an alignment-regulating force in the plurality of optical waveguide regions 20 is not very strong.

In the following, the constituent elements of the optical device 100A according to the present embodiment are described in detail.

### Substrates 50a and 50b

One of the substrates 50a and 50b from which light is emitted has translucency. Both the substrates 50a and 50b may have translucency. Similarly, one of the electrodes 62a and 62b from which light is emitted has translucency. Both the electrodes 62a and 62b may have translucency. At least either the electrode 62a or the electrode 62b may be formed, for example, from a transparent electrode. In the examples shown in FIGS. 8A to 9C, light may be emitted via the upper structure 100a from the optical waveguide regions 20, light may be emitted via the lower structure 100b from the optical waveguide regions 20, or light may be emitted via the upper structure 100a and the lower structure 100b.

### Plurality of Partition Walls 73

The plurality of partition walls 73 are provided on the dielectric layer 51. The plurality of partition walls 73 are placed at equal spacings along the Y direction. Each of the plurality of partition walls 73 has a structure extended along the X direction. Parts of portions of the dielectric layer 51 located between the plurality of partition walls 73 when seen from the Z direction are removed. As a result of that, a plurality of portions that are parts of the reflecting surface 40s of the mirror 40 are exposed. The plurality of exposed portions are placed at equal spacings along the Y direction. Each of the plurality of exposed portions has a shape extending in the X direction. The upper surface of the lower structure 100b has the plurality of exposed portions. As shown in FIG. 9C, portions of the dielectric layer 51 that were not removed and partition wall 73 lying directly on those portions form projections extending along the X direction. Accordingly, a plurality of projections located along the Y direction are formed on the mirror 40. A plurality of depressions are formed between the plurality of projections. The depressions also have structures extending along the X direction. The depth of each depression, i.e. the height of projections located on both sides of each depression, can be, for example, greater than or equal to 1 μm and less than or equal to 10 μm. The depth of a depression and the height of a projection here mean dimensions each measured along the Z direction in the drawing. In Embodiment 1, the plurality of depressions are formed by the dielectric layer 51 and the plurality of partition walls 73, and the plurality of depressions define the plurality of optical waveguide regions 20. In a case where the number of depressions is 1, a single optical waveguide region 20 is formed.

### Plurality of Optical Waveguide Regions 20

When seen from the Z direction, the plurality of optical waveguide regions 20 are defined by regions where the plurality of depressions are located. Each of the optical waveguide regions 20 is surrounded by the reflecting surface 30s of the mirror 30, the reflecting surface 40s of the mirror 40, and two adjacent projections. The optical waveguide regions 20 contain the liquid crystal material 21.

The optical waveguide regions 20 are higher in refractive index than the partition walls 73 and the dielectric layer 51. Light propagating along the X direction through an optical waveguide region 20 does not leak to projections located on both sides of the optical waveguide region 20. This is because the light is totally reflected off the interface between the optical waveguide region 20 and each of the projections. A region where a projection is present can be referred to as a “non-waveguide region”. A plurality of the optical waveguide regions 20 and a plurality of the non-waveguide regions are alternately located along the Y direction between the mirror 30 and the mirror 40. This configuration is equivalent to a plurality of the optical waveguides 10 arranged in the Y direction. The mirror 30 is located between a region where the plurality of optical waveguide regions 20 and the plurality of non-waveguide regions are alternately located along the Y direction and the substrate 50a. The mirror 40 is located between the region where the plurality of optical waveguide regions 20 and the plurality of non-waveguide regions are alternately located along the Y direction and the substrate 50b.

### Electrodes 62a and 62b

The electrodes 62a and 62b face each other with the liquid crystal material 21 indirectly sandwiched therebetween. The phrase “indirectly sandwiched” means that the liquid crystal material 21 is sandwiched between the electrodes 62a and 62b with another member interposed therebetween. In Embodiment 1, the mirror 30, the alignment film 22, and the mirror 40 are placed between the electrodes 62a and 62b. The electrode 62a and the mirror 30 may swap positions with each other. In that case, the alignment film 22 can be formed on a surface of the electrode 62a. Similarly, the electrode 62b and the mirror 40 may swap positions with each other. By adjusting a voltage that is applied to the electrodes 62a and 62b, the refractive index of the liquid crystal material 21 can be adjusted. By changing the voltage, the angle of emission of light that is emitted outward via the upper structure 100a from the optical waveguide regions 20 is changed.

### Plurality of Optical Waveguides 11

The plurality of optical waveguides 11 are connected separately to each of the plurality of optical waveguide regions 20. Light is supplied from the optical waveguides 11 to the optical waveguide regions 20. In the examples shown in FIGS. 8A to 9C, the optical waveguides 11 are located on the dielectric layer 51. The dielectric layer 51 is located between the substrate 50b and the optical waveguides 11. By adjusting the size of the dielectric layer 51 in the Z direction, light propagating through the optical waveguides 11 can be efficiently coupled to the optical waveguides 10. The size of the dielectric layer 51 in the Z direction can be adjusted, for example, so that the optical waveguides 11 are located near the centers of the optical waveguide regions 20 in the Z direction. The optical waveguides 11 are waveguides that cause light to propagate by total reflection. For this reason, the optical waveguides 11 are higher in refractive index than the dielectric layer 51. It should be noted that the optical waveguides 11 may be slow light waveguides.

Each of the plurality of optical waveguides 11 includes a portion located between two of the plurality of partition walls 73 that are adjacent to each other. As shown in FIGS. 8B to 9A, each optical waveguide 11 includes a grating 15 for coupling light to a corresponding one of the optical waveguide regions 20. The grating 15 has a periodic structure along the X direction. The propagation constant of the optical waveguide 11 is different from the propagation constant of an optical waveguide 10. The grating 15 causes the propagation constant of the optical waveguide 11 to shift by a reciprocal lattice of the periodic structure. The reciprocal lattice of the periodic structure is a value obtained by multiplying the reciprocal of a period by 2x. If the propagation constant of the optical waveguide 11 shifted by the reciprocal lattice coincides with the propagation constant of the optical waveguide 10, light propagating through the optical waveguide 11 is efficiently coupled to the optical waveguide 10.

Each of the plurality of optical waveguides 11 includes a portion that, when seen from the Z direction, overlaps the substrate 50a but does not overlap the substrate 50b. Each optical waveguide 11 may include a grating 13 in the portion that does not overlap the substrate 50b. For reasons similar to the reasons set forth above, light inputted via the grating 13 can be coupled to the optical waveguide 11 with higher efficiency. Each optical waveguide 11 may include a portion that overlaps the substrate 50b but does not overlap the substrate 50a or may include a portion that overlaps neither the substrate 50a nor the substrate 50b.

### Alignment Film 22

The alignment film 22 is a rubbing alignment film whose direction of alignment is defined by rubbing. The alignment film 22 is provided on the reflecting surface 30s of the mirror 30 included in the lower surface of the upper structure 100a. The reflecting surface 30s of the mirror 30 is a flat surface or an uneven surface having a difference in height less than 1 μm. The liquid crystal material 21 covers the flat surface or the uneven surface. An alignment film provided on such a surface can have a direction of alignment uniformly defined by rubbing. Although the alignment film 22 has a strong alignment-regulating force, no alignment film is provided on the upper surface of the lower structure 100b. Accordingly, an alignment-regulating force in the optical waveguide regions 20 is not very strong. However, in a case where no voltage is applied to the electrode 62a or 62b, the alignment of the liquid crystal material 21 thus injected can be maintained.

### Seal Member 79

The seal member 79 fixes a spacing between the upper structure 100a and the lower structure 100b. As shown in FIGS. 8B to 8D, the seal member 79 surrounds the plurality of optical waveguide regions 20 and the plurality of partition walls 73 when seen from the Z direction.

In the examples shown in FIGS. 8B to 8D, the seal member 79 has a first portion extending along the Y direction across the plurality of optical waveguides 11 when seen from the Z direction and two second portions extending along the X direction from both ends of the first portion. In the example shown in FIG. 8B, the seal member 79 further has two third portions extending along the Y direction toward each other from ends of the two second portions and two fourth portions extending along the X direction outward from ends of the two third portions. Note, however, that the shape of the seal member 79 is not limited to the examples shown in FIGS. 8B to 8D. The seal member 79 may schematically have, for example, a circular shape or an elliptical shape, and a part of the shape may be open.

The seal member 79 is placed on the dielectric layer 51. An upper surface of the seal member 79 is parallel to an X-Y plane. The size in the Z direction of a portion of the seal member 79 located directly above the dielectric layer 51 is equal to or greater than the sum of the thicknesses (i.e. sizes in the Z direction) of each of the partition walls 73, the mirror 30, and the alignment film 22. The seal member 79 can be formed, for example, from ultraviolet curable resin or thermosetting resin. The material of the seal member 79 does not need to be ultraviolet curable resin or thermosetting resin, as long as the member can maintain the spacing between the substrate 50a and the substrate 50b for a long period of time.

The seal member 79 has a wide opening 790 through which the liquid crystal material 21 is injected. The opening 790 has a width 79ow in the Y direction. In the example shown in FIG. 8B, the opening 790 is defined by the ends of the two third portions and the two fourth portions, and in the examples shown in FIGS. 8C and 8D, the opening 790 is defined by the two second portions. In the example shown in FIG. 8B, the width 79ow of the opening 790 in the Y direction is narrower than a width in the Y direction of a region sandwiched between the two second portions. In the examples shown in FIGS. 8C and 8D, the width 79ow of the opening 790 in the Y direction is equal to a width in the Y direction of a region sandwiched between the two second portions of the seal member 79.

After the upper structure 100a and the lower structure 100b have been bonded together, the liquid crystal material 21 is injected by flowing through the opening 790 of the seal member 79 in a vacuum atmosphere into a space surrounded by the seal member 79. After that, the opening 790 is sealed by the same material as the seal member 79. The region thus hermetically sealed is wholly filled with the liquid crystal material 21.

In the optical device 100A according to Embodiment 1, as shown in FIGS. 8B to 8D, the width 79ow of the opening 790 in the Y direction is greater than the width 20w of the plurality of optical waveguide regions 20 in the Y direction. When seen from the X direction, both ends of the opening 790 are located further outward than both ends of the plurality of optical waveguide regions 20. The width 79ow of the opening 790 in the Y direction can be, for example, 1.05 times or more, preferably 1.1 times or more, even more preferably 1.3 times or more, as great as the width 20w of the plurality of optical waveguide regions 20 in the Y direction.

By injecting the liquid crystal material through such a wide opening 790, the direction of flow of the liquid crystal material 21 is made constant, and in the plurality of optical waveguide regions 20, the occurrence of variations in the alignment of the liquid crystal material 21 due to fluidized alignment can be reduced, even if an alignment-regulating force in the plurality of optical waveguide regions 20 is not very strong. As a result of that, lights can be emitted in the same direction via the upper structure 100a from the plurality of optical waveguide regions 20. This makes it possible to restrain a decrease in the intensity of emitted light.

The plurality of optical waveguide regions 20 guide light in a direction that intersects or, more specifically, is orthogonal to the direction in which the opening 790 has a width. The direction of flow of the liquid crystal material 21 during injection of the liquid crystal material 21 through the opening 790 is a direction opposite to the direction in which the plurality of optical waveguide regions 20 guide light. In a case where the direction of flow of the liquid crystal material 21 is such a direction, the liquid crystal material 21 can be easily injected into the plurality of optical waveguide regions 20.

In a configuration in which the plurality of partition walls 73 are not provided, the seal member 79 may have an opening in a portion close to either of two optical waveguide regions 20 located at both ends of the plurality of optical waveguide regions 20. The opening has a width in the X direction. The width of the opening in the X direction is wider than a width of the plurality of optical waveguide regions 20 in the X direction. When seen from the Y direction, both ends of the opening 790 are located further outward than both ends of the plurality of optical waveguide regions 20. The direction in which the plurality of optical waveguide regions 20 guide light is parallel to the direction in which the opening has a width. Injecting the liquid crystal material 21 through such an opening makes the direction of flow of the liquid crystal material 21 constant, making it possible to reduce the occurrence of variations in the alignment of the liquid crystal material 21 due to fluidized alignment.

In order to reduce the occurrence of variations in the alignment of the liquid crystal material 21 due to fluidized alignment, the optical device 99 according to the comparative example may be configured such that in the example shown in FIG. 6B, a shortest distance 79d between the plurality of optical waveguide regions 20 and the opening 790 is lengthened. However, such a configuration causes a wide range to be surrounded by the seal member 79, thus ending up in an increase in size of the optical device 99. It should be noted that when seen from the Z direction, the shortest distance 79d is equivalent to the shortest distance of a spacing in the X direction between a smallest rectangle that includes all of the plurality of optical waveguide regions 20 and each of the third portions.

On the other hand, in the optical device 100A according to Embodiment 1, the width 79ow of the opening 790 is simply widened in the Y direction; therefore, even if the shortest distance 79d is short as shown in FIG. 8B, the occurrence of variations in the alignment of the liquid crystal material 21 due to fluidized alignment can be reduced. The shortest distance 79d can be, for example, 0.2 time or less as great as the width 20w of the plurality of optical waveguide regions 20 in the Y direction. In a configuration in which the third portions and the fourth portions are not provided as shown in FIGS. 8C and 8D, it is assumed that the shortest distance 79d is zero. Thus, the optical device 100A according to Embodiment 1 makes it possible to restrain an increase in size of the optical device 100A, as the shortest distance 79d can be shortened.

In the opening 790, as shown in FIG. 8D, the plurality of spacers 79s may be provided. Although, in the example shown in FIG. 8D, the number of spacers 79s is 7, this number is not intended to impose any limitation. The number of spacers 79s is any number that is greater than or equal to 1.

In the example shown in FIG. 8D, the plurality of spacers 79s are arranged along the Y direction. A spacing between two of the plurality of spacers 79s that are adjacent to each other is greater than a maximum width of each of the two spacers 79s. The spacing can be, for example, 1.5 times or more, more preferably twice or more, as great as the maximum width of each of the two spacers 79s. A configuration in which the spacing is greater than the maximum width of each of the two spacers 79s makes it possible to, in injecting the liquid crystal material through the opening 790, reduce the possibility of the plurality of spacers 79s causing variations in the alignment of the liquid crystal material.

In the examples shown in FIGS. 8B and 8C, in a case where the width of the opening 790 in the Y direction is, for example, less than or equal to 8000 μm, the spacing between the upper structure 100a and the lower structure 100b in the opening 790 of the seal member 79 is substantially constant regardless of a central portion or both end portions of the opening 790. On the other hand, in a case where the width of the opening 790 in the Y direction is, for example, greater than 8000 μm, the spacing between the upper structure 100a and the lower structure 100b in the opening 790 is may become gradually narrower from both end portions of the opening 790 toward the central portion. This results in nonuniformity in thickness of the plurality of optical waveguide regions 20, and the angles of emission of lights that are emitted via the upper structure 100a from the plurality of optical waveguide regions 20 do not come into line, so that there is a possibility that the intensity of emitted light may decrease.

On the other hand, in the example shown in FIG. 8D, the spacing between the upper structure 100a and the lower structure 100b in the opening 790 of the seal member 79 is substantially constant regardless of position in the opening 790 and an area around the opening 79s. Accordingly, such a decrease in the intensity of emitted light can be restrained. In the example shown in FIG. 8D, there are no size restrictions on the width of the opening 790 in the Y direction.

Although, in the example shown in FIG. 8D, the plurality of spacers 79s are applied to the configuration shown in FIG. 8C, the plurality of spacers 79s may be applied to the configuration shown in FIG. 8B. In that case, the plurality of spacers 79s may be provided in the opening 790, may be provided in the area around the opening 790, or may be provided in the opening 790 and the area therearound. The area around the opening 790 falls within a distance of 2000 μm from the opening 790.

For all these reasons, in the optical device 100A according to Embodiment 1, the occurrence of variations in the alignment of the liquid crystal material 21 due to fluidized alignment can be reduced in the plurality of optical waveguide regions 20 by injecting the liquid crystal material 21 through the wide opening 790. This results in making it possible to restrain a decrease in the intensity of emitted light that is emitted via the upper structure 100a from the plurality of optical waveguide regions 20.

The following describes specific examples of the materials and sizes of constituent elements used in the fabrication of the optical device 100 according to Embodiment 1. The size in the Z direction is hereinafter also referred to as “thickness”.

First, specific examples of the materials and sizes of the constituent elements of the upper structure 100a are described.

The substrate 50a may be formed, for example, from a SiO₂ layer. The sizes of the substrate 50a in the X direction and the Y direction can be, for example, 8 mm and 20 mm, respectively, and the thickness of the substrate 50a can be, for example, 0.7 mm.

The electrode 62a can be formed, for example, from an ITO sputtered layer. The thickness of the electrode 62a can be, for example, 50 nm.

The mirror 30 can be a multilayer reflective film. The multilayer reflective film can be formed, for example, by alternately depositing and stacking a Nb₂O₅ layer and a SiO₂ layer. The Nb₂O₅ layer has a refractive index n of 2.282. The thickness of the Nb₂O₅ layer can be, for example, approximately 100 nm. The SiO₂ layer has a refractive index n of 1.468. The thickness of the SiO₂ layer can be, for example, approximately 200 nm. The mirror 30 has, for example, a total of thirteen layers, namely seven Nb₂O₅ layers and six SiO₂ layers. The thickness of the mirror 30 can be, for example, 1.9 μm.

Next, examples of the materials and sizes of the constituent elements of the lower structure 100b are described.

The substrate 50b can be formed, for example, from a SiO₂ layer. The sizes of the substrate 50b in the X direction and the Y direction can both be, for example, 15 mm. The thickness of the substrate 50b can be, for example, 0.7 mm.

The electrode 62b can be formed, for example, from an ITO sputtered layer. The thickness of the electrode 62b can be, for example, 50 nm.

The mirror 40 can be a multilayer reflective film. The multilayer reflective film can be formed, for example, by alternately depositing and stacking a Nb₂O₅ layer and a SiO₂ layer. The Nb₂O₅ layer has a refractive index n of 2.282. The thickness of the Nb₂O₅ layer can be, for example, approximately 100 nm. The SiO₂ layer has a refractive index n of 1.468. The thickness of the SiO₂ layer can be, for example, approximately 200 nm. The mirror 40 has, for example, a total of sixty-one layers, namely thirty-one Nb₂O₅ layers and thirty SiO₂ layers. The thickness of the mirror 40 can be, for example, 9.1 μm.

The dielectric layer 51 can be formed, for example, from a SiO₂ deposited layer. The SiO₂ deposited layer has a refractive index n of 1.468. The thickness of the SiO₂ deposited layer can be, for example, approximately 1.0 μm.

Each of the optical waveguides 11 can be formed, for example, from a Nb₂O₅ deposited layer. The Nb₂O₅ deposited layer has a refractive index n of 2.282. The thickness of the Nb₂O₅ deposited layer can be, for example, approximately 300 nm. The optical waveguide 11 can have formed therein a grating 15 and a grating 13. The grating 15 has, for example, a duty ratio of 1:1 and a pitch of 640 nm. The grating 13 has, for example, a duty ratio of 1:1 and a pitch of 680 nm. The grating 15 and the grating 13 can be formed by patterning based on a photolithographic method. The size of the optical waveguide 11 in the Y direction can be, for example, 10 μm.

Each of the partition walls 73 can be formed, for example, from a SiO₂ deposited layer. The SiO₂ deposited layer has a refractive index n of 1.468. The thickness of the SiO₂ deposited layer can be, for example, approximately 1.0 μm. The size of the partition wall 73 in the Y direction can be, for example, 50 μm.

In each of the optical waveguide regions 20, a part of the dielectric layer 51 can be removed, for example, by patterning based on a photolithographic method. The thickness of each of the optical waveguide regions 20 can be, for example, 2.0 μm. The size of each of the optical waveguide regions 20 in the Y direction can be, for example, 10 μm.

As the liquid crystal material 21, 5CB liquid crystal can be used, for example. The alignment film 22 can be made of, for example, polyimide. The thickness of a polyimide alignment film is, for example, approximately 80 nm, and the thickness can vary from 0 nm to 150 nm. The polyimide alignment film is thick, and its thickness is not uniform. Light falling on such a polyimide alignment film is absorbed and scattered. The polyimide alignment film can be formed by applying a polyimide solution as an alignment material to the reflecting surface 30s of the mirror 30 and dry-curing the polyimide solution. Depending on how the polyimide alignment film is formed, the polyimide alignment film can also be provided on a surface of the upper structure 100a other than the reflecting surface 30s of the mirror 30. Since the polyimide alignment film functions as an insulator, at least a part of the electrode 62a is exposed for energization without being covered with the polyimide alignment film.

As the seal member 79, ThreeBond's ultraviolet-curable adhesive 3026E can be used, for example. In one example, the upper structure 100a, which is provided with the alignment film 22, and the lower structure 100b can be bonded together by curing the seal member 79 by irradiating the seal member 79 with ultraviolet radiation with a wavelength 365 nm and an energy density of 100 mJ/cm². This bonding gives the optical device 100A according to Embodiment 1.

The spacers 79s can be formed, for example, from silica or the same material as the seal member 79. The maximum width of each of the spacers 79s can be, for example, greater than or equal to 0.5 μm and less than or equal to 10 μm.

It should be noted that the substrates 50a and 50b may be formed from a material other than SiO₂. The substrates 50a and 50b may, for example, be inorganic substrates made of glass or sapphire or resin substrates made of acrylic or polycarbonate. These inorganic substrates and resin substrates have translucency and can therefore be used as the substrates 50a and 50b.

The transmittance of the mirror 30, from which light is emitted, is for example 99.9%, and the transmittance of the mirror 40, from which no light is emitted, is for example 99.99%. This condition can be achieved by adjusting the numbers of layers of the multi-layer reflective films. Two layers may be combined into each of the multilayer reflective films. One of the two layers has a refractive index higher than or equal to 2, and the other of the two layers has a refractive index lower than 2. A great difference between the two refractive indices can bring about a high reflectance. The layer having a refractive index higher than or equal to 2 may be formed from at least one selected from the group consisting of SiNₓ, AlNₓ, TiOₓ, ZrOₓ (1.7≤x≤2.0), NbO_{y}, and TaO_{y} (2.2≤y≤2.5). The layer having a refractive index lower than 2 may be formed from at least one selected from the group consisting of SiOₓ and AlOₓ.

The refractive index of the dielectric layer 51 can be, for example, lower than 2. The refractive index of each of the optical waveguides 11 can be, for example, higher than or equal to 2. A great difference between the two refractive indices can reduce evanescent light that exudes from the optical waveguide 11 into the dielectric layer 51.

### Embodiment 2

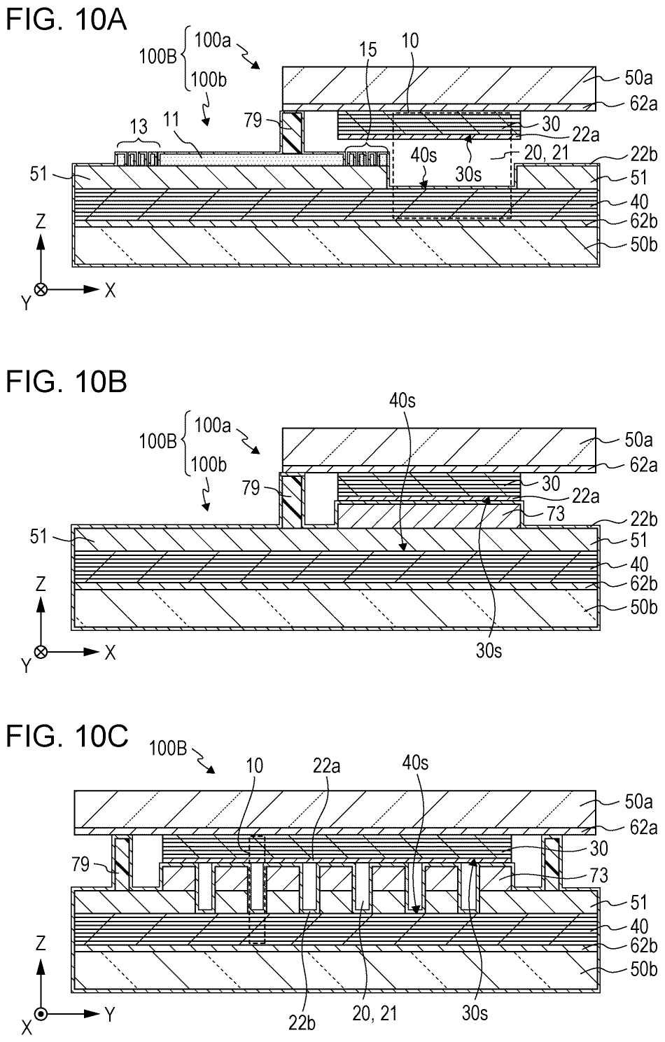

Next, an optical device according to Embodiment 2 of the present disclosure is described with reference to FIGS. 10A to 10C. The optical device of the present embodiment differs from the optical device of Embodiment 1 in that optical device of the present embodiment includes not only an alignment film provided on a surface of the first structure 100a but also an alignment film provided on surfaces of the second structure 100b and the seal member 79. Note, however, that unlike the alignment film provided on the surface of the first structure 100a, the alignment film provided on the surfaces of the second structure 100b and the seal member 79 is formed by a method other than rubbing. The following describes the optical device according to Embodiment 2 with a focus on points of difference from the optical device according to Embodiment 1.

FIGS. 10A to 10C are cross-sectional views schematically showing a configuration of an optical device 100B according to an exemplary Embodiment 2 of the present disclosure. FIGS. 10A to 10C correspond to FIGS. 9A to 9C, respectively. A structure of the optical device 100B as seen from the Z direction is the same as the structure shown in FIG. 8A except that an alignment film is provided on the surfaces of the lower structure 100b and the seal member 79. The optical device 100B shown in FIGS. 10A to 10C includes the upper structure 100a, the lower structure 100b, the plurality of optical waveguide regions 20, a first alignment film 22a, a second alignment film 22b, and the seal member 79. The first alignment film 22a has a structure that is identical to that of the aforementioned alignment film 22. The second alignment film 22b is an alignment film formed by a method other than rubbing. The second alignment film 22b is provided on upper, lower, and side surfaces of the lower structure 100b and upper and side surfaces of the seal member 79. More specifically, the second alignment film 22b is provided on surfaces of the substrate 50b, the mirror 40, the dielectric layer 51, the partition walls 73, the seal member 79, and the optical waveguides 11 that would be exposed were it not for the second alignment film 22b.

The second alignment film 22b can be, for example, a photo-alignment film whose direction of alignment is defined by irradiation with polarized light. The second alignment film 22b can be, for example, a film bonded via a siloxane bond to the surfaces of the second structure 100b, more specifically a monomolecular alignment film. The siloxane bond brings about improvement in adhesion and coverage of a monomolecular film. The monomolecular alignment film can be fabricated at low cost. In the examples shown in FIGS. 10A to 10C, for convenience of fabrication of the optical device 100B, the second alignment film 22b is also provided on surfaces other than the reflecting surface 40s of the mirror 40 in the lower structure 100b. However, the second alignment film 22b does not necessarily need to be provided on the surfaces other than the reflecting surface 40s of the mirror 40 in the lower structure 100b.

As mentioned above, the upper surface of the lower structure 100b has a plurality of depressions having depths greater than or equal to 1 μm and less than or equal to 10 μm. The liquid crystal material 21 covers the plurality of depressions. It is not easy to form, on such a surface of the second structure 100b having a plurality of depressions, a rubbing alignment film that causes a liquid crystal material to be aligned in a particular direction. Projections located on both sides of each depression are obstacles to rubbing and can cause unevenness in the direction of alignment. Furthermore, rubbing may destruct the projections and hinder functions of the optical waveguide regions 20 as waveguides. On the other hand, in a case where the second alignment film 22b is formed by irradiation with polarized light, an alignment film 22b that causes a liquid crystal material to be aligned in a particular direction can be easily formed. It is desirable that the projections not have such shapes as to block irradiation of an alignment film with polarized light. Such shapes can be, for example, inverse tapered shapes whose widths become gradually wider away from the reflecting surface 40s of the mirror 40.

Since the second alignment film 22b is thin and does not function as an insulating layer, portions of the second alignment film 22b provided on the surfaces other than the reflecting surface 40s of the mirror 40 do not cause problems even if they remain. Accordingly, the step of removing the second alignment film 22b can be omitted from the fabrication of the optical device 100B. Depending on application, the portions of the second alignment film 22b provided on the surfaces other than the reflecting surface 40s of the mirror 40 may be removed.

The optical device 100B according to Embodiment 2, in which the first alignment film 22a and the second alignment film 22b are provided, can further improve an alignment-regulating force in the optical waveguide regions 20 to some extent than can the optical device 100A according to Embodiment 1.

For all these reasons, in the optical device 100B according to Embodiment 2, the effect of maintaining the alignment of the liquid crystal material 21 injected into the plurality of optical waveguide regions 20 can be improved in a case where no voltage is applied to the electrode 62a or 62b. The optical device 100B according to Embodiment 2 brings about effects that are similar to those of the optical device 100A according to Embodiment 1.

### Modification

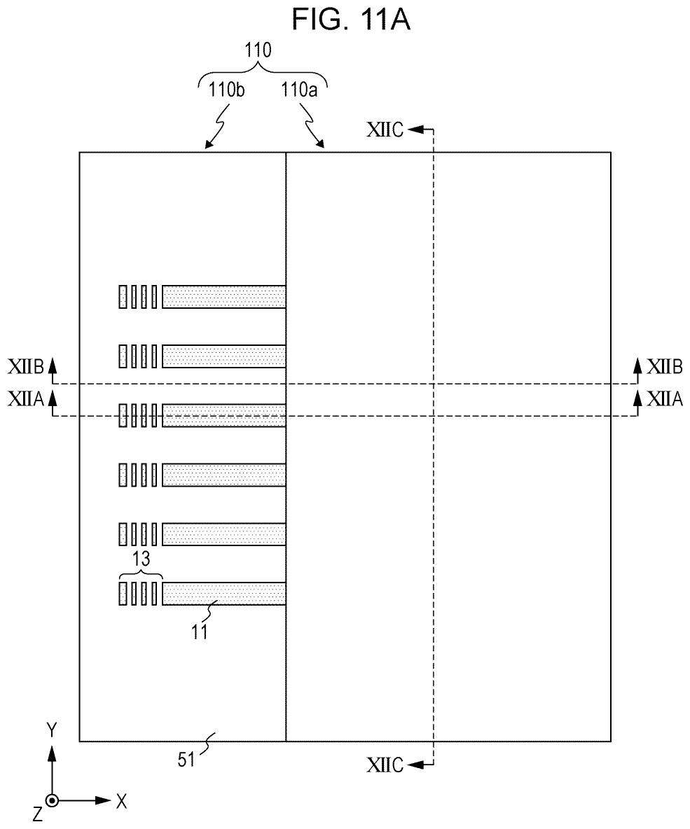

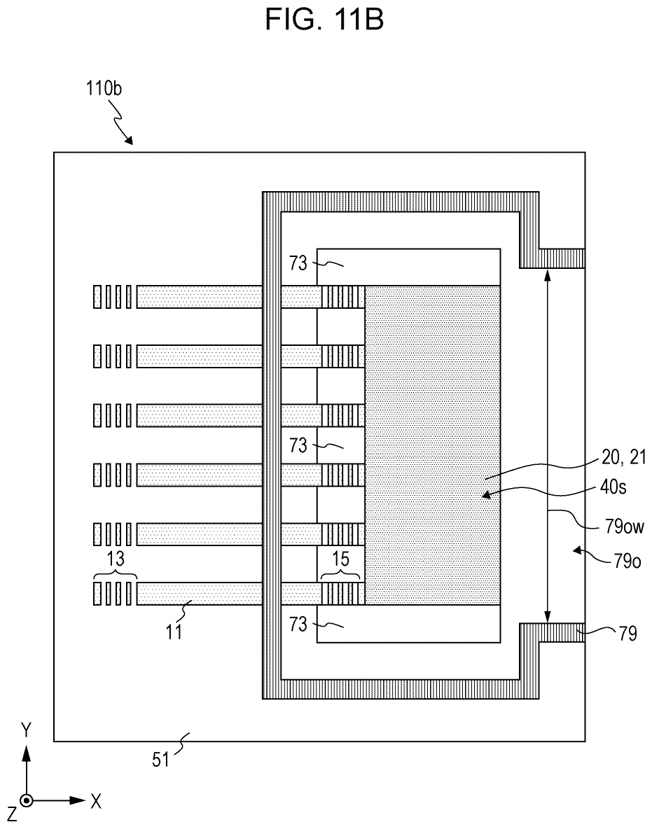

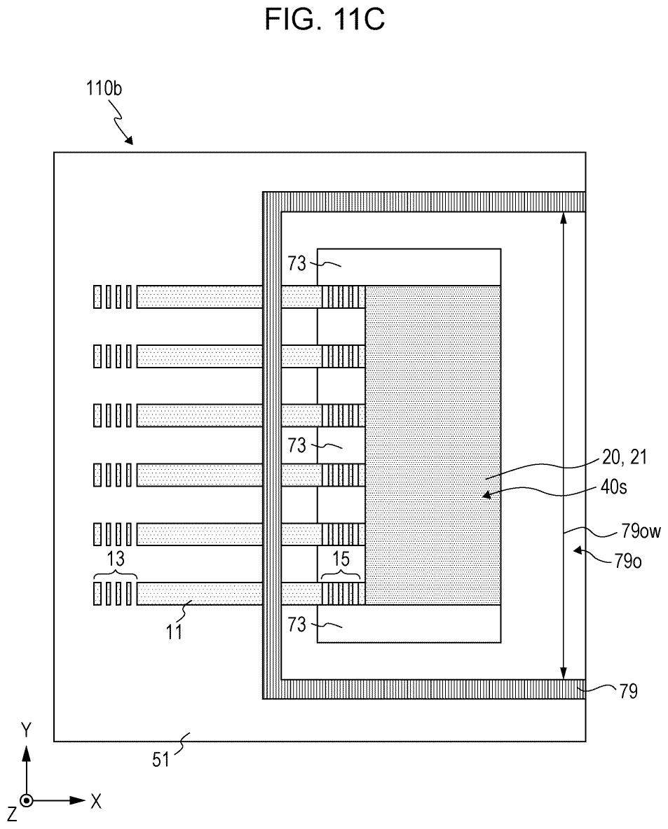

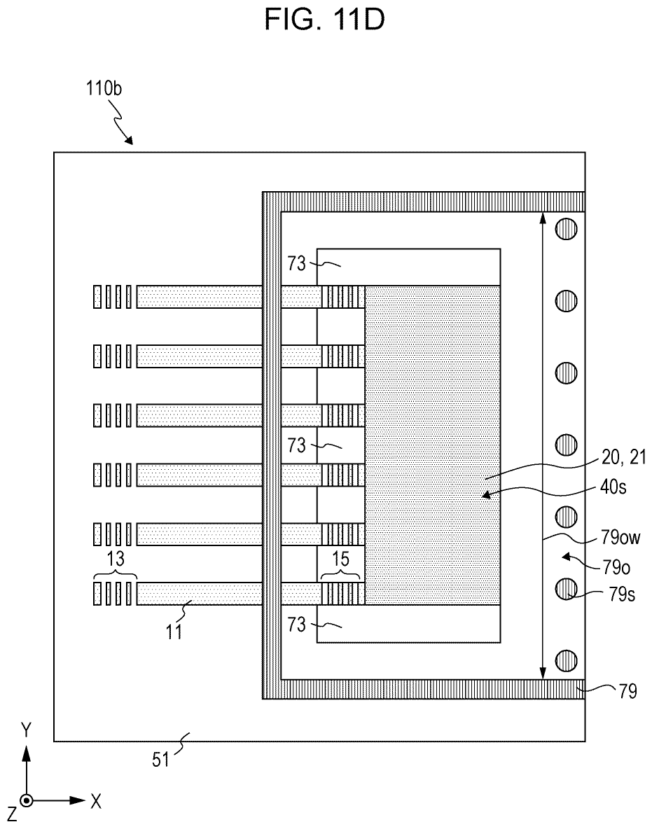

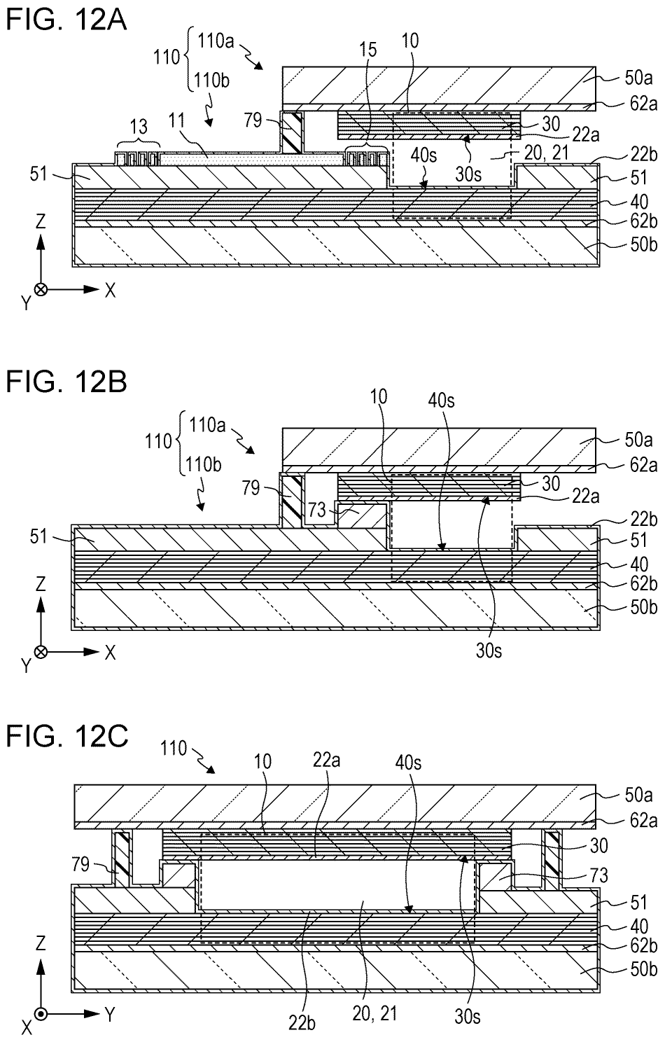

In the optical device 100A according to Embodiment 1 and the optical device 100B according to Embodiment 2 are each provided with a plurality of optical waveguide regions 20 arranged in the Y direction. However, it is not essential to provide a plurality of optical waveguide regions 20, and only one optical waveguide region 20 may be provided. Such an optical waveguide region 20 may be, for example, one planar optical waveguide. In the following, a modification of the optical device 100B according to Embodiment 2 is described with reference to FIGS. 11A to 12C. The modification to be described below can also be applied to the optical device 100A according to Embodiment 1. The only difference between the optical device 100B according to Embodiment 2 and the optical device 100A according to Embodiment 1 is the presence or absence of the second alignment film 22b. FIG. 11A is a top view schematically showing an example of an optical device 110 according to the present modification as seen from the Z direction. Note, however, that FIG. 11A omits to illustrate the second alignment film 22b. FIGS. 11B to 11D are diagrams each schematically showing an example of a state where the upper structure 100a was removed from the structure shown in FIG. 11A. The seal members 79 shown in FIGS. 11B to 11D are the same as the seal members 79 shown in FIGS. 8B to 8D, respectively. The spacers 79s shown in FIG. 11D are the same as the spacers 79s shown in FIG. 8D. FIGS. 12A, 12B, and 12C are a cross-sectional view taken along XIIA-XIIA, a cross-sectional view taken along XIIB-XIIB, and a cross-sectional view taken along XIIC-XIIC in FIG. 11A, respectively.

An upper structure 110a has the same structure as the upper structure 100a in Embodiment 2. On the other hand, in a lower structure 110b, unlike in the lower structure 100b in Embodiment 2, as shown in FIGS. 11B to 11D, two partition walls 73 are placed on both sides of one optical waveguide region 20. As shown in FIGS. 12A to 12C, the lower structure 110b has a comparatively wide depression. Such a structure causes the reflecting surface 40s of the mirror 40 to be exposed across a comparatively wide area spreading along the X direction and the Y direction. The size of the mirror 40 may be reduced so that the whole of the reflecting surface 40s of the mirror 40 and the exposed portion match. That is, the exposed portion may be a part or the whole of the reflecting surface 40s of the mirror 40. Accordingly, an upper surface of the lower structure 110b can be said to have at least a part of the reflecting surface 40s of the mirror 40.

As shown in FIG. 12C, the depression is located between two projections extending in the X direction. In this example, a planar optical waveguide is formed by the reflecting surface 30s of the mirror 30, the reflecting surface 40s of the mirror 40, and one optical waveguide region 20 located between the reflecting surface 30s of the mirror 30 and the reflecting surface 40s of the mirror 40 and spread along the X direction and the Y direction. The optical waveguide region 20 is surrounded by the reflecting surface 30s of the mirror 30, the reflecting surface 40s of the mirror 40, and two projections formed by the partition walls 73. The optical waveguide region 20 is filled with a liquid crystal material 21.

As shown in FIGS. 11B to 11D, the plurality of optical waveguides 11 are connected to the optical waveguide region 20 in the planar optical waveguide 10. Light propagating through the plurality of optical waveguides 11 is coupled to the optical waveguide region 20. The light thus coupled form a light beam by interfering inside the optical waveguide region 20. The light beam formed inside the optical waveguide region 20 is emitted outward via the mirror 30, the electrode 62a, and the substrate 50a. Also in the optical device 110 according to the modification, an X-direction component and a Y-direction component of the wave number vector of emitted light can be changed.

In this example, due to the influence of a stepped portion situated at an edge of the depression, satisfactory alignment performance cannot be achieved especially in the stepped portion in a case where the second alignment film 22b is formed by rubbing. To address this problem, the second alignment film 22b is formed by a non-rubbing method such as irradiation with polarized light. This makes it possible to form a second alignment film 22b having satisfactory alignment performance even in the stepped portion.

In Embodiments 1 and 2 and the modification, the optical waveguides 10 are slow light waveguides. However, the optical waveguides 10 do not need to be slow light waveguides. For example, each of the optical waveguides 10 may be, for example, an optical waveguide that does not include the mirror 30 or the mirror 40 and causes light to propagate through the inside of the optical waveguide region 20 by total reflection off a surface of the substrate 50a and a surface of the substrate 50b. The light propagating through the optical waveguide can be emitted outward not via the substrate 50a or the substrate 50b but, for example, from an end portion of the optical waveguide 10.

### Examples of Application

### Examples of Application to Optical Scan Device

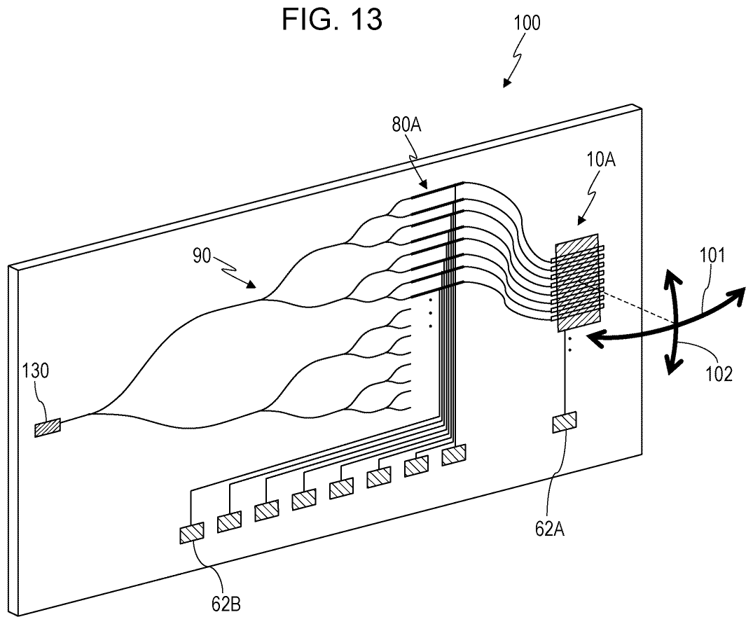

FIG. 13 is a diagram showing an example configuration of an optical scan device 100 in which elements such as an optical divider 90, a waveguide array 10A, a phase shifter array 80A, and a light source 130 are integrated on a circuit board (e.g. a chip). The optical scan device 100 encompasses the optical devices according to Embodiments 1 and 2 and the modification thereof. The light source 130 can be, for example, a light-emitting element such as a semiconductor laser. In this example, the light source 130 emits single-wavelength light whose wavelength in free space is 2. The optical divider 90 divides the light from the light source 130 into lights and introduces the lights into waveguides of the plurality of phase shifters 80. In the example shown in FIG. 13, there are provided an electrode 62A and a plurality of electrodes 62B on the chip. The waveguide array 10A is supplied with a control signal from the electrode 62A. To the plurality of phase shifters 80 in the phase shifter array 80A, control signals are sent from the plurality of electrodes 62B, respectively. The electrode 62A and the plurality of electrodes 62B can be connected to a control circuit (not illustrated) that generates the control signals. The control circuit may be provided on the chip shown in FIG. 13 or may be provided on another chip in the optical scan device 100.

As shown in FIG. 13, an optical scan over a wide range can be achieved through a small-sized device by integrating all components on the chip. For example, all of the components shown in FIG. 13 can be integrated on a chip measuring approximately 2 mm by 1 mm.

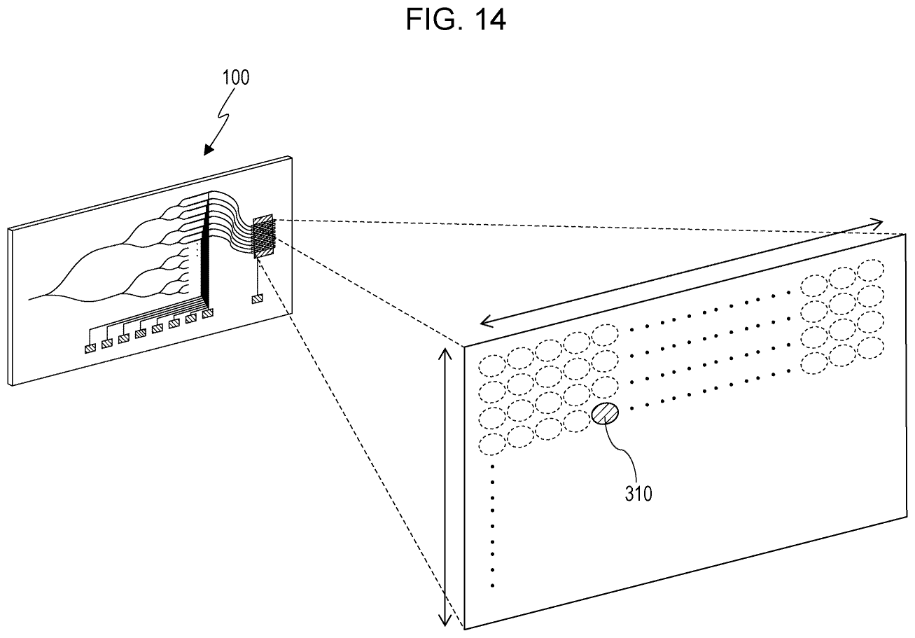

FIG. 14 is a schematic view showing how a two-dimensional scan is being executed by irradiating a distant place with a light beam such as a laser from the optical scan device 100. A two-dimensional can is executed by moving a beam spot 310 in horizontal and vertical directions. For example, a two-dimensional ranging image can be acquired by a combination with a publicly-known TOF (time-of-flight) method. The TOF method is a method for, by observing light reflected from a physical object irradiated with a laser, calculating the time of fight of the light to figure out the distance.

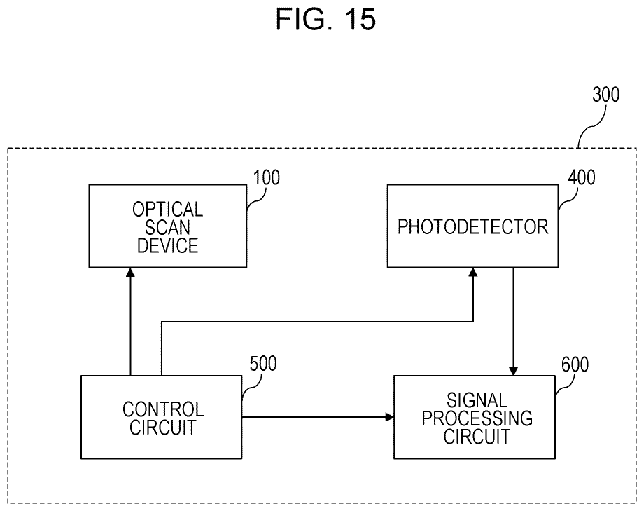

FIG. 15 is a block diagram showing an example configuration of a LiDAR system 300 serving as an example of a photodetection system that is capable of generating such a ranging image. The LiDAR system 300 includes an optical scan device 100, a photodetector 400, a signal processing circuit 600, and a control circuit 500. The photodetector 400 detects light emitted from the optical scan device 100 and reflected from a physical object. The photodetector 400 can be, for example, an image sensor that has sensitivity to the wavelength λ of light that is emitted from the optical scan device 100 or a photodetector including a photo-sensitive element such as a photodiode. The photodetector 400 outputs an electrical signal corresponding to the amount of light received. The signal processing circuit 600 calculates the distance to the physical object on the basis of the electrical signal outputted from the photodetector 400 and generates distance distribution data. The distance distribution data is data that represents a two-dimensional distribution of distance (i.e. a ranging image). The control circuit 500 is a processor that controls the optical scan device 100, the photodetector 400, and the signal processing circuit 600. The control circuit 500 controls the timing of irradiation with a light beam from the optical scan device 100 and the timing of exposure and signal readout of the photodetector 400 and instructs the signal processing circuit 600 to generate a ranging image.

The frame rate at which a ranging image is acquired by a two-dimensional scan can be selected, for example, from among 60 fps, 50 fps, 30 fps, 25 fps, 24 fps, or other frame rates, which are commonly used to acquire moving images. Further, in view of application to an onboard system, a higher frame rate leads to a higher frequency of acquisition of a ranging image, making it possible to accurately detect an obstacle. For example, in the case of a vehicle traveling at 60 km/h, a frame rate of 60 fps makes it possible to acquire an image each time the vehicle moves approximately 28 cm. A frame rate of 120 fps makes it possible to acquire an image each time the vehicle moves approximately 14 cm. A frame rate of 180 fps makes it possible to acquire an image each time the vehicle moves approximately 9.3 cm.

The time required to acquire one ranging image depends on the speed of a beam scan. For example, in order for an image whose number of resolvable spots is 100 by 100 to be acquired at 60 fps, it is necessary to perform a beam scan at 1.67 us per point. In this case, the control circuit 500 controls the emission of a light beam by the optical scan device 100 and the storage and readout of a signal by the photodetector 400 at an operating speed of 600 KHz.

### Example of Application to Optical Receiver Device

The optical devices according to Embodiments 1 and 2 and the modification thereof can also be used as optical receiver devices of similar configurations. Such an optical receiver device includes a waveguide array 10A which is identical to that of the optical scan device and a first adjusting element that adjusts the direction of light that can be received. Each of the first mirrors 30 of the waveguide array 10A transmits light falling on a side thereof opposite to a first reflecting surface from the third direction. Each of the optical waveguide layers 20 of the waveguide array 10A causes the light transmitted through the first mirror 30 to propagate in the second direction. The direction of receivable light that is taken into each of the optical waveguide layers 20 can be changed by the first adjusting element changing at least one of the refractive index of the optical waveguide layer 20 of each waveguide element 10, the thickness of the optical waveguide layer 20 of each waveguide element 10, or the wavelength of light. Furthermore, in a case where the optical receiver device includes a plurality of phase shifters 80 or 80a and 80b which are identical to those of the optical scan device and a second adjusting element that varies differences in phase among lights that are outputted through the plurality of phase shifters 80 or 80a and 80b from the plurality of waveguide elements 10, the direction of receivable light can be two-dimensionally changed. Using the optical devices according to Embodiments 1 and 2 and the modification thereof as optical receiver devices makes it possible to restrain a decrease in the intensity of received light.

For example, an optical receiver device can be configured such that the light source 130 of the optical scan device 100 shown in FIG. 13 is substituted by a receiving circuit. When light of wavelength λ falls on the waveguide array 10A, the light is sent to the optical divider 90 through the phase shifter array 80A, is finally concentrated on one place, and is sent to the receiving circuit. The intensity of the light concentrated on that one place can be said to express the sensitivity of the optical receiver device. The sensitivity of the optical receiver device can be adjusted by adjusting elements incorporated separately into the waveguide array 10A and the phase shifter array 80A. The optical receiver device is opposite in direction of the wave number vector (in the drawing, the thick arrow) shown, for example, in FIG. 4. Incident light has a light component acting in the direction (in the drawing, the X direction) in which the waveguide elements 10 extend and a light component acting in the array direction (in the drawing, the Y direction) of the waveguide elements 10. The sensitivity to the light component acting in the X direction can be adjusted by the adjusting element incorporated into the waveguide array 10A. Meanwhile, the sensitivity to the light component acting in the array direction of the waveguide elements 10 can be adjusted by the adjusting element incorporated into the phase shifter array 80A. θ and α₀ shown in FIG. 4 are found from the phase difference Δφ of light and the refractive index n_{w} and thickness d of the optical waveguide layer 20 at which the sensitivity of the optical receiver device reaches its maximum. This makes it possible to identify the direction of incidence of light.

An optical scan device and an optical receiver device according to the present disclosure are applicable, for example, to a use such as a LiDAR system that is mounted on a vehicle such as an automobile, a UAV, or an AGV.

What is claimed is:

1. An optical device comprising:
a first structure having a first surface;
a second structure having a second surface facing the first surface;
one or more optical waveguide regions located between the first surface of the first structure and the second surface of the second structure, the one or more optical waveguide regions containing a liquid crystal material; and
a seal member fixing a spacing between the first structure and the second structure, surrounding the one or more optical waveguide regions, and including an opening through which the liquid crystal material is injected,
wherein a width of the opening in a first direction is greater than a width of the one or more optical waveguide regions in the first direction.

2. The optical device according to claim 1, wherein one or more spacers are provided in at least either the opening of the seal member or an area around the opening.

3. The optical device according to claim 2, wherein the one or more spacers include a plurality of spacers.

4. The optical device according to claim 3, wherein a spacing between two of the plurality of spacers that are adjacent to each other is greater than a maximum width of each of the two spacers.

5. The optical device according to claim 1, wherein the width of the opening in the first direction is 1.05 times or more as great as the width of the one or more optical waveguide regions in the first direction.

6. The optical device according to claim 1, wherein when seen from a direction perpendicular to the first surface, a shortest distance between the one or more optical waveguide regions and the opening is 0.2 time or less as great as the width of the one or more optical waveguide regions in the first direction.

7. The optical device according to claim 1, wherein the one or more optical waveguide regions guide light in a second direction that intersects the first direction.

8. The optical device according to claim 1, wherein the one or more optical waveguide regions are a plurality of optical waveguide regions arranged along the first direction.

9. The optical device according to claim 8, wherein the width of the opening in the first direction is greater than a width in the first direction of a smallest rectangle that includes all of the plurality of optical waveguide regions.

10. The optical device according to claim 8, further comprising a plurality of optical waveguides connected separately to each of the plurality of optical waveguide regions,
wherein each of the optical waveguides includes a first grating for coupling the light to a corresponding one of the optical waveguide regions.

11. The optical device according to claim 10, wherein each of the optical waveguides includes a portion that, when seen from a direction perpendicular to the first surface, does not overlap either the first structure or the second structure, and includes a second grating in the portion.

12. The optical device according to claim 10, further comprising a plurality of phase shifters connected either directly or via the optical waveguides separately to each of the plurality of optical waveguide regions.

13. The optical device according to claim 1, wherein
the one or more optical waveguide region are one optical waveguide region to which a plurality of optical waveguides are connected, and
the width of the opening in the first direction is greater than a width of the one optical waveguide region in the first direction.

14. The optical device according to claim 1, wherein
the first structure includes a first mirror,
the second structure includes a second mirror,
the first surface has at least a part of a reflecting surface of the first mirror, and
the second surface has at least a part of a reflecting surface of the second mirror.

15. The optical device according to claim 1, wherein
the one or more optical waveguide regions include a structure that is capable of adjusting a refractive index of the liquid crystal material, and
a direction of light that is emitted from the one or more optical waveguide regions via the first structure or the second structure or a direction of incidence of light that is taken into the one or more optical waveguide regions via the first structure or the second structure is able to be changed by changing the refractive index of the liquid crystal material.

16. The optical device according to claim 15, further comprising a pair of electrodes between which the one or more optical waveguide regions are sandwiched,
wherein the refractive index of the liquid crystal material is able to be changed by applying a voltage to the pair of electrodes.
